(19) United States
(12) Patent Application Publication
(10) Pub. No.: US 2026/0312410 A1
(43) Pub. Date: Oct. 8, 2026

(54) MICRO ENERGY STORAGE SYSTEM

(71) Applicant: SMARTIZER PTY LTD, South Turramurra (AU)

(72) Inventor: DAVOOD DEHESTANI, South Turramurra (AU)

(73) Assignee: SMARTIZER PTY LTD, South Turramurra, NE (AU)

(21) Appl. No.: 19/482,169

(22) PCT Filed: May 7, 2024
(86) PCT No.: PCT/AU2024/050444

§ 371 Date: Nov. 6, 2025

(30) Foreign Application Priority Data
May 8, 2023 (AU) 2023901376

(51) Int. Cl. H02J 3/32; H02J 3/38; H02J 7/80; H02J 13/12; H02J 101/24; H02J 101/28

(52) U.S. Cl. CPC H02J 3/32; H02J 3/38; H02J 7/80; H02J 13/12; H02J 2101/24; H02J 2101/28

(57) ABSTRACT

A power storage device comprising of at least one power storage component integrated with at least one inverter. The at least one power storage component is electrically connectable to an electrical panel, which is in electrical communication to an isolation switch disposed in a main switchboard. Further, the power storage device may comprise of an electrical sensor in wireless communication with the power storage component(s), wherein the electrical sensor is adapted to capture or measure power generation of external sources. A computer system comprising a server for connecting to the power storage device(s) over a network and mobile device for communicating with the server having a controller for commanding the inverter(s) to discharge and to charge the power storage component(s) and wherein the controller connects to the network connector over the network and communicates with an application to analyze the operation of the power storage device(s).

### CROSS-REFERENCE TO RELATED APPLICATIONS

This application claims the benefit of PCT Application Serial No. PCT/AU2024/050444, titled “MICRO ENERGY STORAGE SYSTEM,” filed by Davood Dehestani on May 7, 2024.

This application also claims the benefit of Australian Application Serial No. AU 2023901376, titled “MICRO ENERGY STORAGE SYSTEM,” filed by Davood Dehestani on May 8, 2023.

This application incorporates the entire contents of the foregoing application(s) herein by reference.

### TECHNICAL FIELD

The present invention relates to a power storage device. More particularly it relates to a power storage devices, method of forming the power storage devices and method of using or monitoring the power storage devices wherein the disclosed power storage device is having a high flexibility for size and installations and is lower in cost when compared to existing energy storage systems.

### BACKGROUND

Large-scale battery storage has been introduced on the utility side of the grid to provide a resource for ensuring that excess energy produced, for example during off-peak periods, is not wasted. However, this model can be inefficient for batteries due to the size of the batteries, which result in systems that occupy huge warehouses of space. Such systems also have slow reaction times for rapidly changing events and can require fine control that simply is not possible.

Conventional systems utilize batteries that experience significant loss due to inefficient conversions from AC (transmission) to DC (storage) and back again. Further, existing systems are relatively large and expensive and not easily scalable. Those systems must be managed by an army of highly trained technical staff, which is not practical in small scale. In view of the above-described limitations, it would be desirable to have a less expensive, scalable, more flexible, and easy to control energy storage and distribution system, where congestion is relieved, inefficiency due to the separation between generation and consumption removed, costs and a lack of rapid scalability due to infrastructure and skilled resource diminished and multiple use-cases enable. Additionally, it would be desirable to have a distributed, consumer side, smart energy storage system such as for providing cost efficient energy storage to a household property or building that can be easily installed by a user.

In today's world an enormous amount of energy is being consumed and of which consumption in the form of electricity has become an essential part of modern day living. According to Global Electricity Review 2022, electricity demand has risen by 1,414 TWh from 2020 to 2021. The electric power is supplied to consumers through an electric power grid which synchronously connects the power generators and the consumers by way of transmission and distribution lines operated by one or more control centers. Due to the environmental concerns of fossil fuel being used to generate electricity, renewable resources are now being utilised to reduce carbon emissions. However, to deal with the ever increasing power demands, there is an increase in the need of energy storage systems as well. Moreover, when the AC power source is not available or functional due to power outage/failure, then the energy storage systems act as back up energy and help protect the electricity requirements of a residential premises or commercial unit.

An inverter is an example of an energy storage system, and its basic function is to “invert” the direct current (DC) output into alternating current (AC). With the advancement in inverter technology, the inverters also provide several other services as well such as monitoring of data, advance utility controls etc.

U.S. Pat. No. 7,839,019 discloses a portable power storage and supply system which comprises of an inverter, one or more battery modules and control means for controlling the AC and DC charging and discharging functions for safe and efficient operation wherein the battery modules are separable from the system for providing DC energy for energizing automotive battery jumper cables or for energizing DC powered devices. Further, it discloses that any one or any combination of the AC and DC charging and discharging can be carried at one time.

U.S. Pat. No. 10,355,611 discloses a power conversion and management system comprising an energy resource controller further comprising integrated communications, switching and connection controls, and conversion electronics technology for managing the power conversion facilities within a household. The disclosed system comprises a bi-directional power conversion apparatus for converting either AC power to DC power or DC power to AC power when the sources and sinks differ in a single modular electronic power management unit.

U.S. Pat. No. 7,706,164 discloses an inverter device which has two operation modes including a grid-connected operation mode where the inverter device is interconnected with a commercial power system, and an isolated operation mode where the inverter device is independent of a commercial power system and performs an isolated operation. The inverter device includes an inverter converting direct-current power received from a direct-current power supply of a solar battery array into alternating-current power, a control unit controlling an action of an inverter device, a plug for outputting the alternating-current power converted by the inverter, and a load-connecting receptacle on a path of a power supply line connecting the inverter and the plug, for outputting the alternating-current power.

The existing systems of energy storage have some disadvantages such as being bulky, costly, requiring too many efforts for installation etc. Therefore, there exists a need for an energy storage system which is modular and scalable so that the same can be customized as per the requirement of the user. Also, it should be able to provide a high degree of flexibility at a relatively lower cost than the existing products in this domain.

Any discussion of the prior art throughout the specification should in no way be considered as an admission that such prior art is widely known or forms part of common general knowledge in the field.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, an energy storage apparatus includes a power storage device having a power storage component, and a network connector. A sensor detects conditions for charging the power storage component and for discharging the power storage component. A computer system having a server for connecting to the power storage device over a network and mobile device for communicating with the server with the server having a controller residing thereon and the mobile device having an app residing thereon. The controller includes decision maker for commanding the power conversion component to discharge and to charge the power storage component. The controller communicates with the sensor. The controller connects to the network connector over the network and communicates with the app to analyze the operation of the power storage device. These and other features and advantages will be apparent from a reading of the following detailed description and a review of the appending drawings. It is understood that the foregoing summary, the following detailed description and the appended drawings are explanatory only and are not restrictive of various aspects as claimed.

As discussed above, with an increase in demand of power there is a need for a power storage system that is customizable as per the requirements of a user, has a high flexibility for size and installations and at the same time is lower in cost when compared to existing energy storage systems.

It is therefore an object of the present invention to provide a power storage device that is modular in design and is capable of being scaled to meet the requirements of the user, residential premises or any commercial unit.

It is also an object of the present invention to provide a power storage device that is easy to install and relocate to a new location with customer and non-professional people, if required.

It is also an object of the present invention to provide an architecture of a hardware platform, designed to optimise residential electricity usage and maximise renewal energy utilization.

It is also an object of the present invention to provide a modular plug and play device (MPPD) and load meter and control (LMC) that is user-friendly for end customers, in which end users can easily plug and play the MPPD and LMC as needed, without requiring professional installation. This user-friendly approach allows for greater flexibility and convenience in optimizing residential electricity usage and maximising renewal energy utilization.

It is also an object of the present invention to provide a synchub, which is a mechanical and electrical structure designed to meet electrical and safety regulations. Further, it also provides modularity and plug-and-play capability.

It is also an object of the present invention to provide a central control unit (CCU), which is a multifunctional device combining a measurement unit for monitoring power elements such as solar and grid, breakers, and contactors for safety and regulation compliance (eg. isolation during grid outages), and an IoT unit for communication. It may be an advantage that the CCU can connect to home WiFi, MPPDs, Load Meter and Control (LMC), and the cloud via WiFi or 4G/5G network.

It is also an objection of the present invention to provide a modular plug and play device (MPPD), which is an AC source/load device that can be plugged into the synchub and communicates with the CCU. It can advantageously function as a battery storage unit, electric vehicle charger, or solar inverter, among other possibilities. The MPPD can be controlled remotely via the cloud or ran app through the CCU.

It is also an object of the present invention to provide a load meter and control (LMC), which is a smart plug that can interface between home appliances (such as and not limited to fridges, washing machines, pool pumps etc) and wall sockets. The load meter and control allow to monitor individual loads and enable remote control via the cloud through the CCU.

It is also an object of another present invention to engineer a bidirectional inverter with a power range of 1-3 kW, in which the inverter is specifically designed to facilitate the connection between a 4 to 16-cell lithium iron phosphate (LFP) battery pack and a single-phase 220 V, 50 Hz or 60 Hz grid. The intended application of this bidirectional inverter is for residential energy storage purposes.

It is also an object of another present invention to create an inverter or a battery inverter that would be both lightweight and cost-effective. This would allow for increased portability and affordability and making it an attractive solution for residential battery storage applications. By ensuring that the inverter is lightweight and compact, it makes it easy to transport and install in residential settings. Further, by implementing design strategies and components that would minimize production costs without compromising performance or reliability. It is a further objective of this invention to ensure seamless integration with lithium iron phosphate battery packs and single-phase grids commonly found in residential environments. It is a further objective of this invention to enable the inverter to efficiently manage the flow of energy between the battery pack and the grid, allowing for both charging and discharging operations as needed. By achieving these objectives, the designed bidirectional inverter would provide homeowners with a practical and economical solution for residential energy storage, supporting the transition towards sustainable and self-sufficient energy systems.

It is an object of the present invention to overcome or ameliorate at least one of the disadvantages of the prior art, or to provide a useful alternative.

### Means for Solving the Problem

An aspect of the present invention may relate to an energy storage apparatus, the energy storage apparatus comprising: a power storage device having a power storage component, a power conversion component communicating with the power storage component, and a network connector; a sensor for detecting conditions for charging the power storage component and for discharging the power storage component; a computer system having a server for connecting to the power storage device over a network and mobile device for communicating with the server with the server having a controller residing thereon and the mobile device having an app residing thereon; wherein the controller includes decision maker for commanding the power conversion component to discharge and to charge the power storage component; wherein the controller communicates with the sensor; and wherein the controller connects to the network connector over the network and communicates with the app to analyze the operation of the power storage device.

Preferably, the power conversion component is an inverter. More preferably, the power conversion component is a bi-directional inverter.

Preferably, the power storage component is a component selected from the group consisting of a battery and a battery cell.

Preferably, the sensor is connected to the power storage device. More preferably, the sensor connects to the server over the network.

Preferably, the sensor is a sensor selected from the group consisting of a current sensor, a voltage sensor, and a temperature sensor.

Preferably, the network is the Internet.

Preferably, the controller connects to the network wirelessly.

Preferably, the power storage device can form a micro grid.

Another aspect of the present invention may relate to a method for storing energy comprising: enabling cooperating between a power storage device and a power conversion device; connecting, with a network connector, a controller to the power conversion device; sensing, with a sensor, an environmental condition that indicates that the power conversion device should cause the power storage device to charge or that the power conversion device should cause the power storage device to discharge; and enabling communication between the sensor and a decision maker residing on the controller, so that the controller can receive information relating to the environmental condition and command the power conversion device to charge the power storage device or to discharge the power storage device based upon the environmental condition.

Another aspect of the present invention may relate to a power storage device. More particularly it refers to a power storage device comprising of at least one power storage component with at least one inverter wherein the at least one power storage component is electrically connectable to an electrical panel which in turn is in electrical communication to an isolation switch disposed in a main switchboard and wherein the at least one power storage component is integrated with the at least one inverter. Further, the power storage device of the present invention may comprise of an electrical sensor in wireless communication with the at least one integrated inverter and power storage component, wherein the electrical sensor is adapted to capture or measure power generation of external sources. The power storage device of the present invention may further comprise of a computer system comprising a server for connecting to the at least one power storage device over a network and mobile device for communicating with the server having a controller for commanding the at least one inverter to discharge and to charge the at least one power storage component and wherein the controller connects to the network connector over the network and communicates with a mobile application to analyze the operation of the power storage device.

In accordance with an embodiment of the invention the power storage device of the present invention is a micro energy storage system.

In accordance with an embodiment of the invention the at least one power storage component is integrated with the at least one inverter. Further, in order to get a higher energy storage, a plurality of such integrated inverter and power storage components may be incorporated into the power storage device of the present invention.

Preferably, the first integrated inverter and power storage component is the master integrated inverter and power storage component, and the additional plurality of integrated inverter and power storage components are controlled through the master integrated inverter and power storage component.

In an embodiment of the invention, the electrical panel of the power storage device is a specific plug board suitable for connection with an isolation switch located in the man switchboard functioning to isolate a group of the integrated inverter and power storage components from both grid and load.

In an embodiment of the invention, the electrical sensor is able to capture or measure power generation of external sources such as solar, wind or other energy storage. Thus, it is a part of the power storage device in conditions where an external source of energy generation is to be utilised.

In an embodiment of the invention, the integrated inverter and power storage component comprises of a casing or housing wherein the casing/housing has two parts namely a base part and a cover part, wherein the base part houses/accommodates at least one power storage component such as a battery or a cell, a power conversion board, a control board, a cooling system and a LED light.

In an embodiment of the present invention, the power storage component such as a battery or a cell is chargeable and dischargeable.

In an embodiment of the present invention, the components housed in the base part of the casing are connected together with a prefabricated board wherein the prefabricated board is equipped with components such as bus bars, electrical wires and temperature sensors and wherein the prefabricated board is tightened by screws to the terminals of the at least one battery.

In an embodiment of the present invention, power conversion board is a bi-directional converter which inverts DC power of the at least one battery to AC power and comprises of a circuitry of battery management system and DC contactors, and wherein the control board comprises of Advanced RISC Machine (ARM) based processor and performs all major high level control functions as well as communication functions.

In an embodiment of the present invention, the power storage device of the present invention may further comprise of a computer system which is in communication with a server for connecting to the at least one integrated inverter and power storage component over a network, and a mobile device for communicating with the server having a controller for commanding the at least one inverter to discharge and to charge the at least one power storage component and wherein the controller connects to the network connector over the network and communicates with a mobile application to analyze the operation of the power storage device.

In another aspect of the present invention, wherein the computer system may comprise of one or more processors, a memory in communication with the processor and storing, in code form, the computer executable instructions to perform the computer implemented method for management of power and energy wherein the method comprises the steps of:
receiving a plurality of data wherein (i) the data related to electricity market data is received via the grid market prediction hosted on cloud servers; (ii) the customer input data such as electricity bill is received through the browser and application which is hosted by the customer mobile or computer system; and (iii) the real time power data such as about the power grid sources, solar energy, which is received through the WES firmware located on the WES, which in turn is in communication with the local control and IoT software hosted by the local controller in the master MIIB through the LoRa® communication protocol;
analysing the input data via the inverter's firmware or in case of advance PPB utilising the PPB firmware and processing the information received; and
displaying the decision to charge or discharge the battery.

In an embodiment of the invention, the computer implemented method for management of power and energy to minimize electricity cost may further utilise a remote artificial intelligence (Al) engine wherein the said AI engine may comprise of a cloud-based prediction for optimization, profitability and batch control of integrated inverter and power storage components based on electricity market analysis and forecasting.

In an embodiment of the invention, there is provided a power storage device that is architecturally designed based on the modular and portable energy storage.

In an embodiment of the invention, there is provided a power storage device that is lighter than the existing energy storage systems. Furthermore, the power storage device of the present invention has minimum installation requirements and provides maximum flexibility with minimum cost.

In an embodiment of the invention, there is provided a power storage device that is smarter than the existing energy storage systems as it utilises Artificial Intelligence at the backend for market arbitrage.

In another aspect of the invention, there may be provided an electricity usage management system comprising: a central control unit having a power measurement unit for monitoring power elements from a power source, and an IoT unit for connecting and communicating data with at least one power storage component over a communication network; a booster converter for stepping up input DC voltage from the power source to a higher output DC voltage, which is stored in each power storage component; and wherein the at least one power storage component is each integrated with a battery inverter, wherein the battery inverter converts the stored higher DC voltage to AC output voltage, and wherein the battery inverter has a weight less than 1 kg and wherein the battery inverter can provide a power output up to 3 kW; the at least one power storage component is chargeable and dischargeable, and wherein each power storage component is controlled remotely via the communication network through the central control unit.

Preferably, in one embodiment, the system for use in an outdoor environment, the at least one power storage component each includes a plug connector, wherein each plug connector is adapted to mate in a respective bay each having waterproof socket, wherein the respective bay comprises an electrical isolation breaker; and wherein the respective bay each has a smart locker for securing the at least one power storage component.

Preferably, in another embodiment, the system for use in an indoor environment, the at least one power storage component each includes a plug connector, wherein each plug connector is adapted to mate in a respective bracket each having a socket, wherein the respective bracket comprises an electrical isolation breaker; and wherein the respective bracket each has a securing means for securing the at least one power storage component.

Preferably, the cooling system comprises a heatsink positioned at rear of each power storage component. More preferably, the cooling system further comprises a fan also positioned at the rear of each power storage component.

Preferably, the system further comprises at least one load meter and control device each connectable into a respective wall electricity socket, wherein the at least one load meter and control device allows for monitoring and controlling behaviour of loads within household usage, wherein the at least one load meter and control device is controllable by the central control unit.

Preferably, the central control unit comprises a processor with a memory configured to store a machine learning algorithm for receiving and analysing input data from at least one source to generate optimised energy management instructions, wherein the processor is configured to communicate the energy management instructions to the central control unit which controls the energy management of the at least one power storage component.

Preferably, in another embodiment, the system further comprises cloud storage for storing machine learning algorithm for receiving and/or analysing input data from at least one source to generate a modelled data set, wherein the modelled data set can be wirelessly communicated to the central control unit.

Preferably, the central control unit is in communication with a user interface, wherein the user interface is configured for users to monitor and control their energy usage, and to receive notifications from the processor.

Preferably, the central control unit is in communication to at least one input data selected from the group of: electricity retailer data, real time data on electricity prices and tariff structures, solar data, weather data, energy usage data, and energy consumption data.

Preferably, the central control unit is equipped with mobile connectivity capabilities for remotely providing an alternative communication channel for when WiFi access is unavailable.

Preferably, the power source is at least one selected from the group of: array of solar panels, and the power grid.

Preferably, in one preferred embodiment, the system is applicable for use within at least one setting selected from the group of: a residential setting, a societal setting, and a commercial setting.

Preferably, in another preferred embodiment, wherein the system further comprises cascading boost converters in electrical communication to the power storage component to store a scaled-up voltage and power, and wherein the system is applicable for use within a commercial setting.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 is a schematic diagram of an exemplary micro energy storage system in accordance with the subject disclosure.

FIG. 2 is a schematic diagram of an exemplary micro energy storage system implemented in home.

FIG. 3 is an exemplary process in accordance with the subject disclosure.

FIG. 4 is an exemplary computing device in accordance with the subject disclosure.

FIG. 5 is an exemplary cloud computing system in accordance with the subject disclosure.

FIG. 6 is an exemplary computer system in accordance with the subject disclosure.

FIG. 7 is a block diagram illustrating a power storage device according to an embodiment of the invention.

FIG. 8 is illustrating the casing/housing of the power storage device according to an embodiment of the invention.

FIG. 9 is illustrating the bracket for holding (or sitting on the ground) the power storage device according to an embodiment of the invention.

FIG. 10 is illustrating parts of the casing/housing of the power storage device according to an embodiment of the invention.

FIG. 11 is illustrating the arrangement of the components of the power storage device according to an embodiment of the invention.

FIG. 12 is illustrating the arrangement of the components of pre-fabricated power and sensing connections of the power storage device according to an embodiment of the invention.

FIG. 13 is depicting the power conversion board of the power storage device according to an embodiment of the invention.

FIG. 14 is depicting the wireless sensor of the power storage device according to an embodiment of the invention.

FIG. 15 is illustrating the architecture of the computer implemented method of the power storage device according to an embodiment of the invention.

FIG. 16 is illustrating a schematic line diagram of the electricity usage management system's hardware platform, more particularly designed to optimize residential electricity usage and maximise renewable energy utilisation. It shows a line diagram of how these elements are integrated into the existing wiring system of a home.

FIG. 17 is illustrating a synchub or a locker/casing for organising the integrating the system's energy management components, more specifically suited for an outdoor environment, where the electronics and/or hardware have to be weatherproofed from rain and/or wet environments.

FIG. 18 is illustrating a synchub of a locker/casing for organising the integrating the system's energy management components, more specifically suited for an indoor environment, where the electronics and/or hardware can have a suitable level of protection against indoor environmental conditions, such as humidity and temperature fluctuations and as it is within the secure home itself, the synchub design eliminates the need for bays and locks to prevent easy unauthorised access.

FIG. 19 is illustrating a central control unit (CCU) which is the system's hardware platform.

FIG. 20 is illustrating an IoT Card which facilitates communication and data management between different hardware components within the system.

FIG. 21 is illustrating a front view of an outdoor version of a modular integrated inverter and battery (MIIB).

FIG. 22 is illustrating a back view of the outdoor version of the modular integrated inverter and battery (MIIB) of FIG. 21.

FIG. 23 is illustrating a front view of the indoor version of a modular integrated inverter and battery (MIIB).

FIG. 24 is illustrating a back view of the indoor version of the modular integrated inverter and battery (MIIB) of FIG. 23.

FIG. 25 is illustrating the positioning of the inverter card, DC/DC converter card, heatsink and fan, male connection and battery in a MIIB for reference.

FIG. 26 is illustrating an outdoor four-unit MIIB mounted to the external wall.

FIG. 27 is illustrating an indoor four-unit MIIB mounted to internal wall.

FIG. 28 is illustrating a schematic diagram of a software and communication architecture showing the communication flow.

FIG. 29 is illustrating a mobile application or APP showing the dashboard which provides an overview of key energy metrics etc.

FIG. 30 is illustrating the battery inverter topology in high level

FIG. 31 is illustrating a traditional bidirectional battery inverter which is heavy (approximately 35 kg).

FIG. 32 is illustrating the new bidirectional inverter designed where the weight is less than 2 kg

### DESCRIPTION OF THE INVENTION

Preferred embodiments of the invention will now be described with reference to the accompanying drawings and non-limiting examples.

In this disclosure, when one part (or element, device, etc.) is referred to as being ‘connected’ to another part (or element, device, etc.), it should be understood that the former part can be ‘directly connected’ to the latter part, or ‘electrically connected’ to the latter part via an intervening part (or element, device, etc.).

The subject disclosure is directed to a micro energy storage system and, more particularly, to a micro energy storage system that includes a power storage device with a storage component cooperating with a power conversion component and a controller for controlling the conversion component. The controller can communicate with a computer system over a network, so that a software application or app can be used to analyze various aspects of the power consumption of the power storage device.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment”, “an embodiment”, “an example embodiment”, “one implementation”, “an implementation”, “one example”, “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to an “app”, an “application”, and a “software application” shall refer to a computer program or group of programs designed for end users. The terms shall encompass standalone applications, thin client applications, thick client applications, web-based applications, such as a browser, and other similar applications.

Numerous specific details are set forth in order to provide a thorough understanding of one or more embodiments of the described subject matter. It is to be appreciated, however, that such embodiments can be practiced without these specific details.

Various features of the subject disclosure are now described in more detail with references to the drawings, wherein like numerals generally refer to like or corresponding elements or features throughout. The drawings and detailed description are not intended to limit the claimed subject matter to the particular form described. Rather, the intention is to cover all modifications, equivalents and alternatives falling within the spirit and scope of the claimed subject matter.

The subject disclosure is directed to a full, turnkey platform solution of a domestic energy storage based on the concept of a decentralised micro power conversion system (PCS). Such a system can integrate with various battery cells including lithium batteries. The system does not need a battery pack that has a High DC voltage.

The platform utilizes off-the-shelf battery cells and can include components/software to provide battery protection, along with a bidirectional DC/AC converter. The platform also includes a centralized control system (CCS) that can communicate, wirelessly, with multiple micro PCS's in a specific area, such as a single house.

The platform can have plug and play capability for residential or commercial applications, so that the platform activates when devices connect to a wall socket or dedicated PPB. The platform does not need professional installation and/or testing before operation however, if installation is required, that will be with minimum cost.

The platform includes at least two devices, a decentralized power conversion and storage device that includes an inverter, on one hand, and a centralized control device or controller that functions as the brain of the system. The inverter can be a micro battery inverter that integrates with a single lithium battery cell.

The platform can include temperatures and voltage sensors that monitor the temperature of the battery cell to provide the ability to disconnect the power conversion system when environmental conditions are determined to be unsafe.

The controller can include a minimum of one AC current sensor and a centralized control board, which can include a decision maker component residing thereon. The controller can command the inverter, through a wireless connection, to provide the inverter with the ability to charge or to discharge the battery cell.

The controller can implement an algorithm to decide whether to charge or to discharge the cell. The controller can use input data that it receives from sources such as a house load profile, a house generation system (like solar, etc), the electricity bill of the house, grid status, and weather prediction.

The platform can utilize wireless connections, such as WIFI, Zigbee, or other similar or equivalent connections, to connect to the Internet and function as an Internet-of-things (IOT) device. Through the platform, the operation of the power conversion device can be monitored remotely. In some embodiments, multiple inverters can be connected to a central control system, so that the user can have multiple inverters/batteries throughout their home.

Additionally, the inverter can be connected and disconnected from a larger power grid. In some embodiments, the platform can configure the inverter to function in a micro-grid mode, which provides the ability to form a local grid.

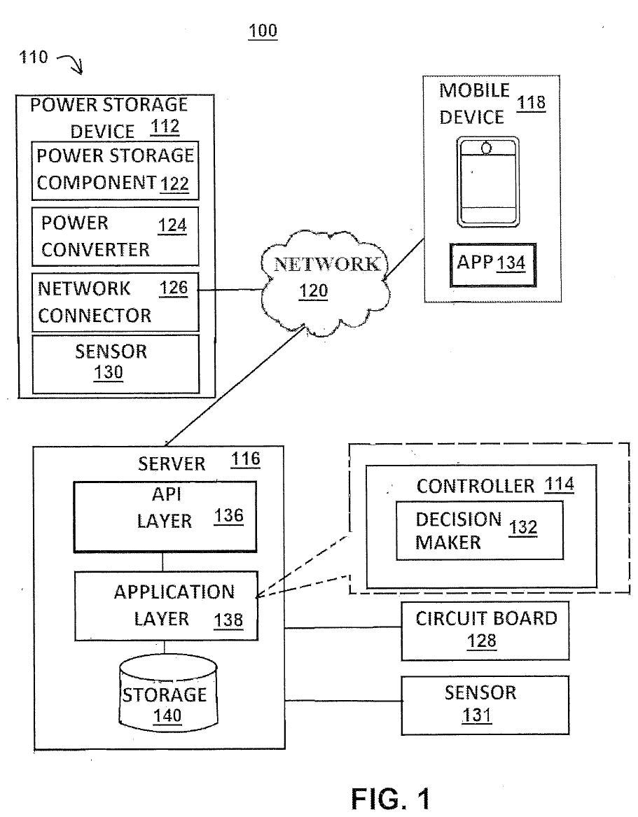

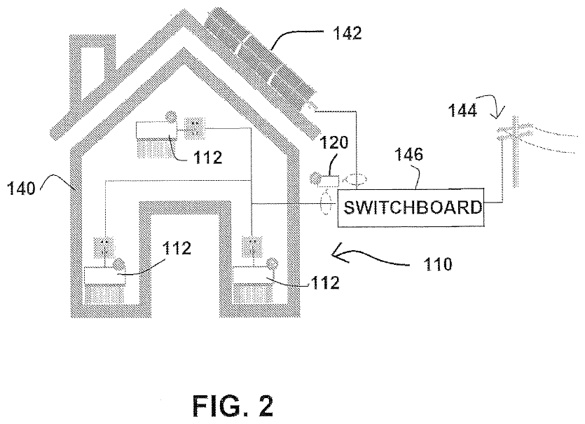

Now referring to the drawings and particularly to FIGS. 1 and 2, various features of the subject disclosure are now described in more detail with respect to an operating environment, generally designated with the numeral 100, for implementing a micro energy storage system 110. The system 110 includes a power storage device 112, a controller 114, a server 116, and a mobile device 118. The controller 114 resides on the server 116.

The power storage device 112 communicates with the controller 114 and/or the server 116 over a network 120 with either a wireless connection or through a house ethernet cable. The mobile device 118 can be configured to communicate over the network 120 with the server 116. The mobile device 118 can be configured to function as an input device, an output device, and/or a display device. The power storage device 112 can form a micro grid.

In some embodiments, the controller 114 and/or the server 116 can be configured to be a server system that includes a large-scale server that functions as part of a virtual power plant through external entities, such as Network Supply Providers (NSP). The server system can communicate with thousands of energy storage systems, including system 110, over the Internet. In such embodiments, the NSPs can regulate network voltage and frequency by commanding specific active and reactive power through controllers, such as controller 113, and servers, such as server 116.

The power storage device 112 includes a power storage component 122, a power conversion component 124, and a network connector 126. The power conversion component 124 cooperates with the power storage component 122 to charge or to discharge the power storage component 122. The network connector 126 can connect the power storage device 112 to the server 116 through a wireless connection. In some embodiments, the power conversion component 124 can be an inverter, such as a bi-directional AC/DC inverter. The power storage component 122 can be a battery and/or a battery cell.

The controller 114 can be implemented on a server 116 that connects to a circuit board 128. The controller 114 can communicate with sensors 130-131. The sensor 130 can be connected to or be inbuilt within the power storage device 112. The sensor 131 can be configured to cooperate with the controller 114. In some embodiments, the sensor 130 is configured for battery protection and power control. In other embodiments, the sensor 131 is configured to check power and energy flow into and out of the system 110.

The server 116 can implement a decision maker 132 for the controller 114. The decision maker 132 can command the power conversion component 124 to discharge and to charge the power storage component 122. The decision maker 132 can be a hardware component, such as a computer system, a computing device, or other electronic device, or a software component, such as an app.

In some embodiments, the sensors 130-131 can be a current sensor, a voltage sensor, and a temperature sensor. In some embodiments, the sensor 130 can be used to monitor the safety of the power storage component 122. The sensor 131 can be used to identify power generation and power load.

Controller 114 can provide and utilize digital and analog input and output. The digital output will be combined with a solid-state relay to provide the function of microgrid for customers that want to disconnect from a power grid in case of grid losses.

The server 116 can include one or more computing devices such as server computers configured to provide various types of services and/or data stores in accordance with the described subject matter. The mobile device 118 can be any type of computing device, including a mobile device, a navigation device, a smartphone, a handheld computer, a tablet, a PC, or any other client device.

Network 120 can be implemented by any type of network or combination of networks including, without limitation: a wide area network (WAN) such as the Internet, a local area network (LAN), a Peer-to-Peer (P2P) network, a Zigbee connection network, a telephone network, a private network, a public network, a packet network, a circuit-switched network, a wired network, and/or a wireless network.

Power storage device 112, controller 114, server 116 and mobile device 118 can communicate via network 120 using various secure communication protocols (eg. Internet communication protocols, WAN communication protocols, LAN communications protocols, P2P protocols, telephony protocols, and/or other network communication protocols), various authentication protocols, and/or various data types (web-based data types, audio data types, video data types, image data types, messaging data types, signalling data types, and/or other data types).

The mobile device 118 can have an app 134 residing thereon for analyzing the operation of the power storage device 112 and/or the controller 114. The server 116 includes an application programming interface layer 136, an application layer 138, and a data storage layer 140. The application interface layer 138 can be configured to implement architecture to interact with the app 134 and to implement the controller 114.

The power storage device 112 can be a small-scale power conversion system that can charge or discharge the power storage component 122, as required by the external environmental condition. The power storage device 112 can maintain battery voltage and current for power that is discharged therefrom at a safe level, as set forth by the standards or the recommendations from the manufacturer of the power storage component 122.

The system 110 provides output power at an AC voltage level as required by local load and grid. The controller 114 can control the charging and/or discharging time and/or power discharge rate as determined through communications with the power storage device 112. The system 110 has the ability to implement grid following and/or grid forming functions and, in some embodiments, can provide on-grid or off-grid solutions through the implementation of the power storage component 112.

The system 110 should function in an autonomous mode in some embodiments and in an auxiliary mode in other embodiments. The system 110 should meet second generation grid requirements.

The power storage device 112 should include an AC contactor to provide the ability to connect or to disconnect from the grid/load as required. The power converter 124 should be able to perform voltage control functions (for grid forming and microgrid) and/or current control functions (for grid following and grid connection). In some embodiments, the system 110 can have the ability to switch between two modes within a few milliseconds.

The power storage component 122, generally, will be small scale. For example, the power produced by the power storage component 122 can be within a power range of about 100 watts to about 1000 watts. In some embodiments, the power storage component 122 produces power of about 200 watts (that is, average continuous power). In such embodiments, the power storage component 122 can be a lithium-ion battery cell, match the DC voltage level of a lithium-ion battery cell and/or include multiple cells, such as 2-4 cells, connected in series to produce a higher voltage. In such embodiments, the power storage component 122 can operate within a range of voltage between about 2.0 volts to about 12.0 volts and can have an operational voltage of about 12.0 volts.

The sensors 130-131 can be a single sensor, multiple sensors, or an array of sensors. Suitable sensors include voltage, current and temperature sensors that can measure battery safety and control characteristics, power flow into and out of the system 110 from external power grids and/or solar cells. Additionally, the controller 114 can include between two and five current transducers (current sensors) and in some embodiments, with at least one of the transducers being a magnetic transducer, or an electromagnetic transducer, or an electrodynamic transducer.

The controller 114 can send commands for charge and/or discharge of the power storage device 112 that can include set points for both active and reactive power. In some embodiments, the power storage device 112 and/or the controller 114 can connect to the Internet to function as an Internet-of-things device with the capability to connect to cloud-based applications. The connections can be wireless connections, such as Zigbee or Wifi, or hardwired cable connections.

As shown in FIG. 2, the system 110 can be implemented within a residence 140 having a power source, such as an array of solar panels 142. The residence 140 can connect to an external power grid 144 through a switchboard 146. The controller 114 can communicate with a plurality of power storage devices 112 within a range of about 1-100 units within the residence 140. Each power storage device 112 will have unique code number as an identifier. The sensor 131 can monitor power and energy flow from the solar panels 142 and the power grid 144 within the residence 140.

As shown in FIG. 1, the power storage device 112 can connect to a cloud-based system that is implement web-based applications or apps to monitor the operation thereof. The controller 114 can provide the ability to connect to external weather prediction websites (not shown) over the network 120 for optimization of power distribution and consumptions. The controller 114 can implement an inbuilt core program for peer communication (through the Internet) between the controller 114 and other similar controllers (not shown).

The server 116 can be used to implement cloud-based applications, including both android and IOS apps, for the controller 114. The server 116 and/or the controller 114 implement various configurations, include modes for stand-alone operation or through an energy marketing platform through a virtual power plant (VPP) platform.

The controller 114 and the server 116 can implement a cloud-based application for providing a virtual power plant that has the capability of providing active and reactive power command to the power storage device 112. The controller 114 can communicate with the app 134 on the mobile device 118 to read and analyze electricity bills (in pdf, text and jpg format) for calculation of KPI required for optimizing energy consumption.

The controller 113 and the server 116 can implement peer-to-peer communication for energy trading and marketing. The controller 114 and the server 116 provide different level of cyber security and protections. The controller 114 and the server 116 can provide different KPI and analysis within different level.

Referring to Figure with continuing reference to the foregoing figures, an exemplary process, generally designated by the numeral 200, for implementing a micro energy storage system is shown. The process 200 can be a computer-implemented method that is performed within the operating environment 100 using the system 110 shown in FIGS. 1 and 2.

At 201, a power storage device cooperates with a power conversion device. In this exemplary embodiment, the power storage device is the power storage component 122 shown in FIGS. 1 and 2. The power conversion device is the power conversion component 124 shown in FIGS. 1 and 2.

At 202, a network connector is connected to a controller to the power conversion device. In this exemplary embodiment, the controller is the controller 114 as shown in FIGS. 1 and 2. The network connector is the network connector 126 as shown in FIGS. 1 and 2. The controller 114 resides on the server 116, as shown in FIGS. 1 and 2.

At 203, a sensor senses an environmental condition that indicates that the power conversion device should cause the power storage device to charge or that the power conversion device should cause the power storage to discharge. In this exemplary embodiment, the sensor is the sensor 130 as shown in FIGS. 1 and 2.

At 204, the sensor communicates with a decision maker residing on the controller, so that the controller can receive information relating to the environmental condition and command the power conversion device to charge the power stage device or to discharge the power storage device based upon the environmental condition. In this exemplary embodiment, the decision maker is the decision maker 132 as shown in FIGS. 1 and 2.

At 205, the power consumption of the power storage device is analyzed. In this exemplary embodiment, the power consumption can be analyzed using applications residing on the server 116, implemented through the controller 114, and/or the mobile device 118 as shown in FIGS. 1 and 2, including app 134.

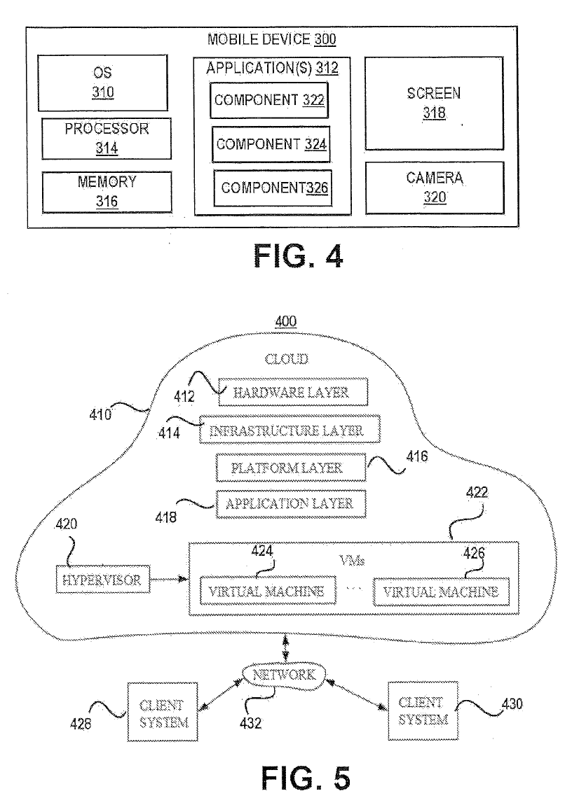

An exemplary computing device is now referring to FIG. 4 with continuing reference to the foregoing figures, a computing device in the form of a mobile device, generally designated by the numeral 300, is illustrated. The mobile device 300 can represent the mobile device 118 as shown in FIG. 1. The mobile device 300 can include operating system 310 and various types of mobile application(s) 312. In some implementations, mobile application(s) 312 can include one or more client application(s) and/or components of a client application.

Mobile device 300 can include processor 314 for performing tasks such as signal coding, data processing, input/output processing, power control, and/or other functions, and memory 316 that can be used for storing data and/or code for running operating system 320 and/or mobile application(s) 312. Example data can include web pages, text, images, sound files, video data, or other data to be sent to and/or received from one or more network servers or other devices via one or more wired and/or wireless networks.

Mobile device 300 can include screen 318 and camera 320. The application(s) 312 can include one or more components 322-326 that implement the functions associated with the app 134 as shown in FIG. 1.

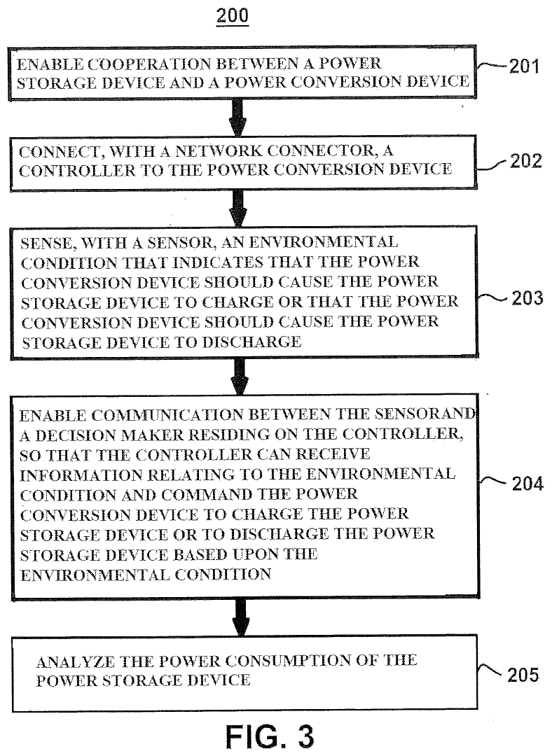

An exemplary cloud architecture is now referred to in FIG. 5 with continuing reference to the foregoing figures. Exemplary cloud architecture, generally designated by the numeral 400, for implementing a micro energy storage system is shown. In this exemplary embodiment, the architecture 400 can be implemented within the operating environment 100 shown in FIG. 1 to practice the method 200 as shown in FIG. 3 using the server 116 and the mobile device 118 as shown in FIG. 1 and/or the mobile device 300 as shown in FIG. 4.

Cloud computing provides computation, software, data access, and storage services that do not require end-user knowledge of the physical location or configuration of the system that delivers the services. In various embodiments, cloud computing delivers the services over a wide area network, such as the internet, using appropriate protocols.

For instance, cloud computing providers deliver applications over a wide area network and they can be accessed through a web browser or any other computing component. Software or components of architecture 400 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud can be managed by the organization itself and the infrastructure is typically not shared with other organizations. The organization still maintains the hardware to some extent, such as installations and repairs, etc.

As shown in FIG. 5, the cloud architecture 400 includes a cloud 410. The cloud 410 (or each of the different premises on the cloud 410) can include a hardware layer 412, an infrastructure layer 414, a platform layer 416, and an application layer 418. In some embodiments, the hardware layer 412 can be equivalent to the controller 114 as shown in FIG. 1.

A hypervisor 420 can illustratively manager or supervise a set of virtual machines 422 that can include a plurality of different, independent, virtual machines 424-426. Each virtual machine can illustratively be an isolated software container that has an operating system and an application inside it. It is illustratively decoupled from its host server by hypervisor 420. In addition, hypervisor 420 can spin up additional virtual machines or close virtual machines, based upon workload or other processing criteria.

A plurality of different client systems 428-430 (which can be end user systems or administrator systems, or both) can illustratively access cloud 410 over a network 432. Depending upon the type of service being used by each of the client systems 428-430, cloud 410 can provide different levels of service. In one example, the users of the client systems are provided access to application software and databases. The cloud service then manages the infrastructure and platforms that run the application. This can be referred to as software as a service (or SaaS). The software providers operate application software in application layer 412 and end users access the software through the different client systems 428-430.

The cloud provider can also use platform layer 416 to provide a platform as a service (PaaS). This involves an operating system, programming language execution environment, database and webserver being provided to the client systems 428-430, as a service, from the cloud provider. Application developers then normally develop and run software applications on that cloud platform and the cloud provider manages the underlying hardware and infrastructure and software layers.

The cloud provider can also use infrastructure layer 414 to provide infrastructure as a service (IaaS). In such as service, physical or virtual machines and other resources are provided by the cloud provider, as a service. These resources are provided, on-demand, by the IaaS cloud provider, from large pools installed in data centers. In order to deploy the applications, the cloud users that use IaaS install operating-system images and application software on the cloud infrastructure 400.

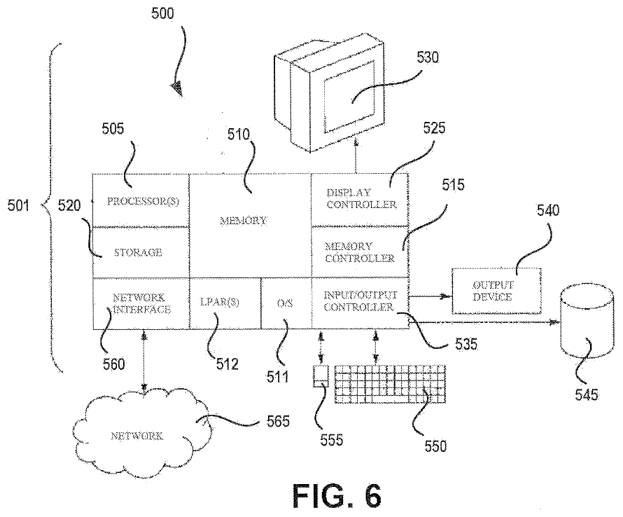

Exemplary Computer System is now referred to in FIG. 6 with continuing reference to the foregoing figures, a computer system for implementing a micro energy storage system is generally shown according to one or more embodiments. The methods described herein can be implemented in hardware, software (eg. firmware), or a combination thereof. In an exemplary embodiment, the methods described herein are implemented in hardware as part of the microprocessor of a special or general-purpose digital computer, such as a personal computer, workstation, minicomputer, or mainframe computer. The system 500 therefore can include general-purpose computer or mainframe 501 capable of running multiple instances of an O/S simultaneously. The system 500 can function as the controller 114 and the server 116 as shown in FIG. 1.

In an exemplary embodiment, in terms of hardware architecture, as shown in FIG. 6, the computer 501 includes one or more processors 505, memory 510 coupled to a memory controller 515, and one or more input and/or output (I/O) devices 540, 545 (or peripherals) that are communicatively coupled via a local input/output controller 535. The input/output controller 535 can be, for example but not limited to, one or more buses or other wired or wireless connections, as is known in the art. The input/output controller 535 can have additional elements, which are omitted for simplicity, such as controllers, buffers (caches), drivers, repeaters, and receivers, to enable communications. Further, the local interface can include address, control, and/or data connections to enable appropriate communications among the aforementioned components. The input/output controller 535 can include a plurality of sub-channels configured to access the output devices 540 and 545. The sub-channels can include fiber-optic communications ports.

The processor 505 is a hardware device for executing software, particularly that stored in storage 520, such as cache storage, or memory 510. The processor 505 can be any custom made or commercially available processor, a central processing unit (CPU), an auxiliary processor among several processors associated with the computer 501, a semiconductor-based microprocessor (in the form of a microchip or chip set), a microprocessor, or generally any device for executing instructions.

The memory 510 can include any one or combination of volatile memory elements (eg. random access memory (RAM, such as DRAM, SRAM, SDRAM, etc)) and non-volatile memory elements (eg. ROM, erasable programmable read only memory (EPROM), electronically erasable programmable read only memory (EEPROM), programmable read only memory (PROM), tape, compact disc read only memory (CD-ROM), disk, diskette, cartridge, cassette, or the like, etc). Moreover, the memory 510 can incorporate electronic, magnetic optical, and/or other types of storage media. Note that the memory 510 can have a distributed architecture, where various components are situated remote from one another, but can be accessed by the processor 505.

The instructions in memory 510 can include one or more separate programs, each of which comprises an ordered listing of executable instructions for implementing logical functions. In the example of FIG. 6, the instructions in the memory 510 is a suitable operating system (OS) 511. The operating system 511 essentially controls the execution of other computer programs and provides scheduling, input-output control, file and data management, memory management, and communication control and related services. In accordance with one or more embodiments, the memory 510 and/or an I/O device 545 can be used to store the file attribute tables and the data layers.

The memory 510 can include multiple logical partitions (LPARs) 512, each running an instance of an operating system. The LPARs 512 can be managed by a hypervisor, which can be a program stored in memory 510 and executed by the processor 505.

In an exemplary embodiment, a conventional keyboard 550 and mouse 555 can be coupled to the input/output controller 535. Other output devices such as the I/O devices 540, 545 can include input devices, for example but not limited to a printer, a scanner, microphone, and the like. Finally, the I/O devices 540, 545 can further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 500 can further include a display controller 525 coupled to a display 530. In an exemplary embodiment, the system 500 can further include a network interface 560 for coupling to a network 565. The network 565 can be an IP-based network for communication between the computer 501 and any external server, client and the like via a broadband connection. The network 565 transmits and receives data between the computer 501 and external systems. In an exemplary embodiment, network 565 can be a managed IP network administered by a service provider. The network 565 can be implemented in a wireless fashion, eg. using wireless protocols and technologies, such as WiFi, WiMax, etc. The network 565 can also be a packet-switched network such as a local area network, wide area network, metropolitan area network, Internet network, or other similar type of network environment. The network 565 can be a fixed wireless network, a wireless local area network (LAN), a wireless wide area network (WAN), a personal area network (PAN), a virtual private network (VPN), intranet or other suitable network system and includes equipment for receiving and transmitting signals.

If the computer 501 is a PC, workstation, intelligent device or the like, the instructions in the memory 510 can further include a basic input output system (BIOS) (omitted for simplicity). The BIOS is a set of essential software routines that initialize and test hardware at startup, start the OS 511, and support the transfer of data among the hardware devices. The BIOS is stored in ROM so that the BIOS can be executed when the computer 501 is activated.

When the computer 501 is in operation, the processor 505 is configured to execute instructions stored within the memory 510, to communicate data to and from the memory 510, and to generally control operations of the computer 501 pursuant to the instructions.

In accordance with one or more embodiments described herein, the computer 501 can implement and/or perform the disclosed subject matter. As shown, computer 501 can include instructions in memory 510 for performing steps associated with the operating environment 100 as shown in FIGS. 1 and 2, the method 200 shown in FIG. 3, and/or the mobile device 300 shown in FIG. 4.

Further, it should be understood that some embodiments, the server 116 shown in FIG. 1 can be implemented through cloud infrastructure, such as the cloud infrastructure 400 shown in FIG. 5, and/or through a conventional computer system, such as the computer system 500 as shown in FIG. 6. In other embodiments, the server 116 as shown in FIG. 1 can be implemented in a hybrid cloud environment that includes cloud infrastructure, such as cloud infrastructure 400 as shown in FIG. 5, and one or more computer systems, such computer system 500 as shown in FIG. 6.

Additionally, it should be understood that the disclosed subject matter can be implemented as a system, a method, and/or a computer program product at any possible technical detail level of integration. The computer program product can include a computer readable storage medium (or media) having computer readable program instructions thereon for causing a processor to carry out embodiments and features of the subject disclosure.

Computer readable storage mediums, as described herein, can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C’ programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, though the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to exploit features of the present disclosure.

Embodiments and features of the subject disclosure are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the subject disclosure.

In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Supported features and embodiments—the detailed description provided above in connection with the appended drawings explicitly describes and supports various features of a micro energy storage system. By way of illustration and not limitation, supported embodiments include an energy storage apparatus comprising: a power storage device having a power storage component, a power conversion component communicating with the power storage component, and a network connector; a sensor for detecting conditions for charging the power storage component and for discharging the power storage component; a computer system having a server for connecting to the power storage device over a network and mobile device for communicating with the server with the server having a controller residing thereon and the mobile device having an app residing thereon; wherein the controller includes decision maker for commanding the power conversion component to discharge and to charge the power storage component; wherein the controller communicates with the sensor; and wherein the controller connects to the network connector over the network and communicates with the app to analyze the operation of the power storage device.

Supported embodiments include the foregoing energy storage apparatus, wherein the power conversion component is an inverter. Supported embodiments include any of the foregoing energy storage apparatus, wherein the power conversion component is a bi-directional inverter. Support embodiments include any of the foregoing energy storage apparatus, wherein the power storage component is a component selected from the group consisting of a battery and a battery cell. Support embodiments include any of the foregoing energy storage apparatus, wherein the sensor is connected to the power storage device. Support embodiments include any of the foregoing energy storage apparatus, wherein the sensor connects to the server over the network. Support embodiments include any of the foregoing energy storage apparatus, wherein the sensor is a sensor selected from the group consisting of a current sensor, a voltage sensor, and a temperature sensor. Support embodiments include any of the foregoing energy storage apparatus, wherein the network is the Internet. Support embodiments include any of the foregoing energy storage apparatus, wherein the controller connects to the network wirelessly. Support embodiments include any of the foregoing energy storage apparatus, wherein the power storage device can form a micro grid.

Supported embodiments include a method for storing energy comprising: enabling cooperating between a power storage device and a power conversion device; connecting, with a network connector, a controller to the power conversion device; sensing, with a sensor, an environmental condition that indicates that the power conversion device should cause the power storage device to charge or that the power conversion device should cause the power storage device to discharge; and enabling communication between the sensor and a decision maker residing on the controller, so that the controller can receive information relating to the environmental condition and command the power conversion device to charge the power storage device or to discharge the power storage device based upon the environmental condition.

Supported embodiments include a system, a computer-readable storage medium, a computer program product and/or means for implementing any of the foregoing apparatus, methods, or portions thereof.

The detailed description provided above in connection with the appended drawings is intended as a description of examples and is not intended to represent the only forms in which the present examples can be constructed or utilized.

It is understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

Another aspect of the present invention may relate to a power storage device. The power storage device comprising at least one power storage component with at least one inverter; wherein the at least one power storage component is electrically connectable to an electrical panel which in turn is in electrical communication to an isolation switch disposed in a main switchboard, and wherein the at least one power storage component is integrated with the at least one inverter.

Preferably, the power storage device of the present invention may comprise of an electrical sensor in wireless communication with the at least one integrated inverter and power storage component, wherein the electrical sensor is adapted to capture or measure power generation of external sources. The power storage device of the present invention may further comprise of a computer system comprising a server for connecting to the at least one power storage device over a network and mobile device for communicating with the server having a controller for commanding the at least one inverter to discharge and to charge the at least one power storage component and wherein the controller connects to the network connector over the network and communicates with a mobile application to analyze the operation of the power storage device.

In accordance with an embodiment of the invention the at least one power storage component is integrated with the at least one inverter. Further, in order to get a higher energy storage, a plurality of such integrated inverter and power storage components may be incorporated into the power storage device of the present invention. The at least one power storage component when integrated with the at least one inverter may be referred to as a Modular Integrated Inverter and Battery (MIIB) herein.

Preferably, the first integrated inverter and power storage component is the master integrated inverter and power storage component, and the additional plurality of integrated inverter and power storage components are controlled through the master integrated inverter and power storage component. In an exemplary embodiment of the invention, a single MIIB may have a capacity of around 4 kWh while it can provide power of 1 kWh to 1.15 kWh. Further, the number of MIIBs can be increased or scaled as per the requirement of the consumer and the power limitation. The first MIIB is usually a master MIIB and the additional MIIBs are slaves. For control grouping, a single master MIIB may cover about but not limited to 50 to 100 additional MIIBs.

In an embodiment of the invention, the electrical panel of the power storage device is a specific plug board suitable for connection with an isolation switch located in the main switchboard functioning to isolate a group of the integrated inverter and power storage components from both grid and load.

In an embodiment of the invention, the electrical sensor is able to capture or measure power generation of external sources such as solar, wind or other energy storage. Thus, it is a part of the power storage device in conditions where an external source of energy generation is to be utilised.

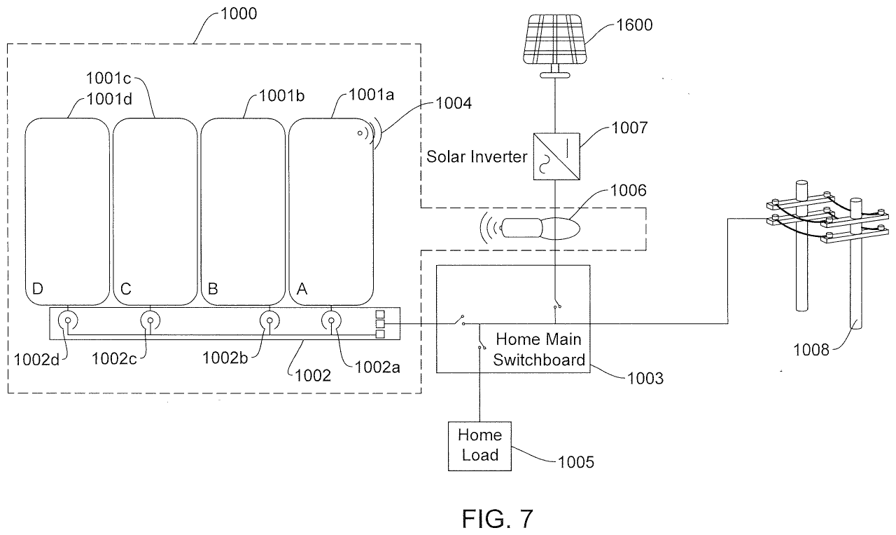

FIG. 7 is showing a block diagram illustrating a power storage device according to an embodiment of the invention. The power storage device 1000 is configured to supple electric energy from a DC source to one or more electrical appliances in a residential set up. As can be seen in FIG. 7 that the power storage device 1000 comprises of a plurality of four power storage components wherein each of the power storage components are integrated inverter and power storage components 1001a to 1001d. The integrated inverter and power storage components are respectively connected to the electrical panel 1002 comprising of individual plugs 1002a to 1002d. Further, the electrical panel is in electrical connection to an isolation switch disposed in a main switchboard 1003. The power transmission line 1008 is supplying power to the main switchboard 1003 of the residential set-up and to the Home Load 1005 wherein the home load 1005 refers to the AC power utilised by the home. The power storage device 1000 may further comprise of an electrical sensor 1006 which is in wireless communication with the at least one integrated inverter and power storage component 1001a-1001d, wherein the electrical sensor 1006 is adapted to capture or measure power generation of external sources, which is solar power herein being obtained through a solar panel 1600 and converted to AC power with the help of a solar inverter 1007.

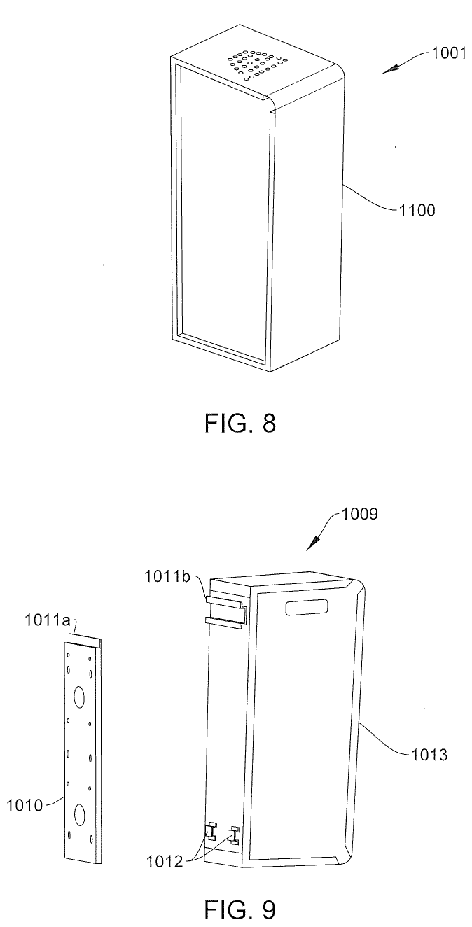

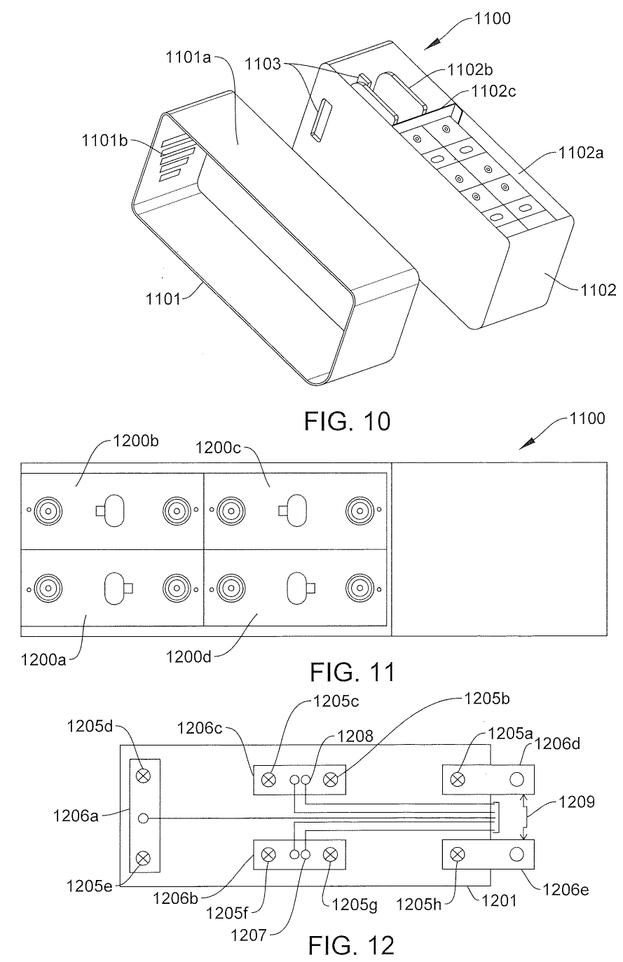

In a further aspect of the present invention, the integrated inverter and power storage component 1001 referred to as a modular integrated inverter and battery (MIIB) herein, is shown in FIG. 8. FIG. 9 is illustrating a bracket for holding (or stabilized on the ground) the power storage device according to an embodiment of the invention, and FIG. 10 is illustrating parts of the casing/housing of the power storage device according to an embodiment of the invention. Referring to FIGS. 8, 9 and 10, the modular integrated inverter battery or the integrated inverter and power storage component 1001 comprises of a casing or housing 1100 wherein the casing/housing 1100 is comprised of two parts, namely, a base part 1102 and a cover part 1101. FIG. 9 is showing a bracket 1009 which is configured in a jig and fixture design, and it comprises of a fixture 1010 and the bracket 1013 wherein the two attach together by securing the clamps 1011a to 1101b at the top portion of the fixture while the clamps 1012 on the bracket secure with its female part on the fixture 1010 at the bottom portion of the bracket assembly 1009. The base part 1102 as shown in FIG. 10 is so designed as to accommodate at least one power storage component such as one or more of a plurality of battery or a cell 1102a, power electronics 1102b and a cooling system (not shown in figures). The battery/batteries 1102a and power electronics 1102b along with cooling section are so arranged as to form two sections in the base part 1102 and the sections are separated by a meshed plate 1102c to allow air to be sucked from the battery section too. The base part 1102 is provided with two concavities 1103 at one end of the base part on opposite sides which help in lifting and handling of one unit of the MIIB. Further, the cover part 1101 is provided with two cutting sections 1101a and 1101b wherein the cutting section 1101b serves as fan exhaust while the cutting section 1101a helps to reflect the light from an LED indicator. The cutting section 1101a for LED light may also be covered with a clear silicon to proof the base from liquid ingress. The LED indicator may be mounted on the power electronics and the light from the LED indicator is reflected through the cutting section. The cutting section 1101a may be cut in any suitable shape such as a line, a circle, an oval or as per the company logo or any other suitable shape.

Furthermore, in an embodiment of the invention, the casing or housing 1100 may be customizable in such a way so as to give enough flexibility to the customer to be used to either sit on the floor or to be installed on the wall or arranged in any other suitable manner. The casing or housing 1100 may be formed in one or more of a plurality of configurations, shapes, sizes and/or material compositions.

FIG. 11 is illustrating the arrangement of the components of the power storage device according to an embodiment of the invention. And FIG. 12 is illustrating the arrangement of the components of connection's cover 1201 of the housing of the power storage device according to an embodiment of the invention. Referring to FIG. 11, the power storage device of the present invention which may comprise one or a plurality of power storage components 1102a, is here shown to comprise of 4 power storage components 1200a to 1200d, which are connected in series with the arrangement as shown in the FIG. 11. It may be appreciated that any number of power storage components can be connected in series. This arrangement is connected together by a prefabricated board 1201 as shown in the FIG. 12. This board 1201 is equipped with five electrical bus bars 1206a to 1206e, five direct wires as seen in FIG. 12, two temperature sensors 1207 and 1208 and tightened by eight screws (or welding) 1205a to 1205h to the terminal of the at least one battery or batteries. The other side 1209 of the board 1201 will connect to the power electronics board 1102b located in the other section of the base part of the housing 1100. The power storage component may be a battery. The battery is preferably able to be charged and discharged. For example, and not limited to, the battery may be a nickel-cadmium battery, a lead acid battery, a nickel metal hydride (NiMH) battery, a sodium ion battery, a lithium ion battery, or a lithium polymer battery, etc.

In an exemplary embodiment, the battery's cells 1200a to 1200d are lithium ion phosphate known as LFP with a nominal voltage of 3.2V per cell. Four cells in series will construct the 12.8V battery system with a maximum 100 amps current and energy of around 280 Ah to 320 Ah. LFP battery chemistry can handle a high range of temperature and heat stress. However, the temperature sensors 1207 and 1208 have been provided for monitoring battery's cells temperature to cut the power in event of thermal runaway. The temperature sensors 1207 and 1208 are integrated with the top board of the hole system. There is also a separate connection to each battery terminal to measure and balance the battery cell voltage through a battery management system (BMS). The BMS electronics and functions are integrated into the power board 1102b however the sensing will come through the middle sensor connections.

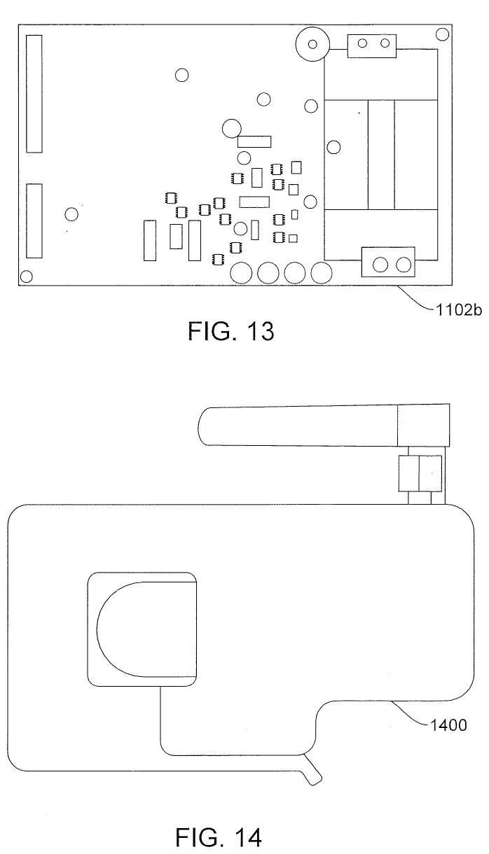

The power electronics of the MIIB is designed from two separate boards including a power conversion board which acts as a converter/inverter board and a control board. The power conversion board or the power electronics board 1102b as shown in FIG. 13 is physically divided into two boards with approximate size to be able to fit into the structure and make a difference between stages for increasing voltages. The power conversion board 1102b mainly functions as a bi-directional converter to invert DC power of the batteries to AC power as required in the residential application and vice versa. Power conversion board 1102b may also comprise of a circuitry of battery management system (BMS) for balancing the battery cells and calculating the state of charge (SoC) as well as state of health (SoH) for the batteries. The power conversion board 1102b further includes DC contactors to cut the battery power in case of emergency events such as thermal runaway or safety emergencies. Preferably, both the power electronic boards 1102b are designed with their related heatsinks to provide maximum cooling rate out of these boards.

The control board which is a part of the power electronics of the MIIB is the brain of the system with a strong ARM (Advanced RISC Machine) based processor. The control board performs all major high level control functions as well as communication functions. Most of the high-level control functionality that is needed by the power conversion board 1102b is performed by this control board. This board physically sits on the power conversion board 1102b and communicates together fast. The control board may handle different communication protocols such as Ethernet, Bluetooth, Wi-Fi, LoRa with different sections. Internal wireless communications between power storage device are between master modular integrated inverter battery (MIIB) or the integrated inverter and power storage component, slave MIIBs and wireless electric sensor (WES). LoRa and LoRa WAN may be utilised as the protocol to establish communication between internal power storage device equipments. On the other hand, the control board is configured to have both Wi-Fi and Bluetooth for connectivity to the customer mobile as well as the network of the building. This control board performs initial set up of the system as well as local optimization for energy shifting and energy trading. Generally, the control board is designed for all internet of things (IoT) functions as well as higher level of control, management and optimization.

The power storage device of the present invention further comprises of a cooling system. The base part 1102 as shown in FIG. 10 is designed to accommodate a cooling system. The cooling system is designed with consideration of two heatsinks mounted on the power electronic boards 1102b and a single fan installed at the end of the base part 1102 of the casing 1100. The fan may be installed at the end of the power electronic compartment to suck the air form both power electronic boards 1102b as well as batteries in the first part 1102a. The casing 1100 may have some holes at the end of the power electronic compartment to allow heat and dust pumped out of the casing through the fan. Furthermore, the power storage device of the present invention also comprises a dedicated LED which shows the status of the individual MIIB during operation. The colour of the LED may show the status of MIIB operation, for example. A light green colour would show that MIIB is healthy and discharging or dark green colour would show that MIIB is healthy, and discharging or red colour may indicate MIIB is faulted and so on. The reflection of the LED can be seen as a simple line or company brand or any dedicated type of flag from the cutting 1101a in the cover 1101 of the casing 1100.

Referring to FIG. 7 which is showing a block diagram illustrating a power storage device according to an embodiment of the invention, the electrical panel 1002 may be so designed as to connect directly to the building power walls or alternatively the electrical panel may be designed a plug and play board (PPB). The PPB provides for a lower installation cost as well as the flexibility of plug and play of the master and additional MIIBs. The electrical panel as a plug and play board address the requirements for the grid regulation and battery inverter standard. The electrical panel or board has a dedicated isolation switch in the main switchboard 1003 in a facility or a residence. Further, the electrical panel 1002 may be of basic version or an advanced version. The basic electrical panel of plug and play board (PPB) is utilised when functions such as energy shifting, and demand management are required. This is suitable for grid connecting applications in which MIIBs remain connected as long as the voltage of the grid is being sensed. MIIB will disconnect internally in the absence of the grid voltage. The basic PPB doesn't include internal relays for backup solution in absence of grid (i.e., disconnecting the grid and connecting MIIBs directly to the load). The MIIBs will disconnect internally (via internal relays) if for any reason the grid cannot be sensed and will reconnect when the grid can be sense at the point of connection. On the other hand, the advanced version is suitable option for off-grid, microgrid and backup function while it may also function as grid connecting when grid is available. This type of PPB may comprise of at least two internal relays to manage connecting load and MIIBs when grid is not available. The combination of PPB relays and MIIB's internal relays work as a group for islanding situations. When the sense of grid disappears (in the event of grid failure), the relevant grid relay in the PPB gets disconnected and at this moment the MIIB enters the grid forming and islanding mode and continues to provide power to the loads without interruption. The integrated inverter and power storage component or the MIIB have the capability of grid forming and black start in case of off grid application requirement. Input PPB for grid connection can be used for any other source of AC generators such as genset for microgrid application. The electrical panel or the PPB is connected to a basic isolation switch located in the main switchboard to be able to isolate group of MIIBs from both grid and load. The basic version of the electric panel may be a plug and play board (PPB) that can connect up to 4 MIIBs and thereby giving a flexibility of 1.1 kW up to 4.4 kW of power as well as 4 kWh to 16 kWh of energy storage. While the advanced version of the electrical panel may be able to connect more than 4 MIIBs up to 8 MIIBs thereby giving a flexibility of 1.1 kW to 8.8 kW of power as well as 4 kWh to 32 kWh of energy storage. The main purpose of the isolation switch is for safety as per standard requirements. Preferably, the electrical panel may be provided with a mechanical lock with each plug connection of individual MIIB.

FIG. 14 is depicting the wireless sensor 1400 of the power storage device according to an embodiment of the invention. The Wireless Electric Sensor (WES) 1400 may have a generic shape similar to as shown in FIG. 14. The WES doesn't need an installation process. Wireless Electric Sensor (WES) 1400 is designed to provide a hybrid solution for those facilities/customers/residences where an external source of power such as solar, wind, genset or other energy storage is also being utilised. The main aim of WES 1400 is to provide visibility of other sources of generations (in terms of quantity and status) in in order to use for optimal decision of charge and discharge and minimise the cost. This system is able to gather, analyze, and transmit the sensory information regarding the power information, providing better efficiency and power management. In an embodiment of the invention the WES (1400) is in communication with the master MIIB through the LoRa® communication protocol to reduce total power usage and wide range distance. LoRa® is the de facto wireless platform of Internet of Things (IoT). The communication between WES 1400 and master MIIB 1001a, referring to FIG. 7, will automatically be established once Master MIIB 1001a energises for the first time. It is installed by opening the lock, putting it around the relevant generation cable (i.e., AC cable comes out of the photovoltaic (PV) inverter), and closing the lock by pushing top and bottom of the WES 1400.

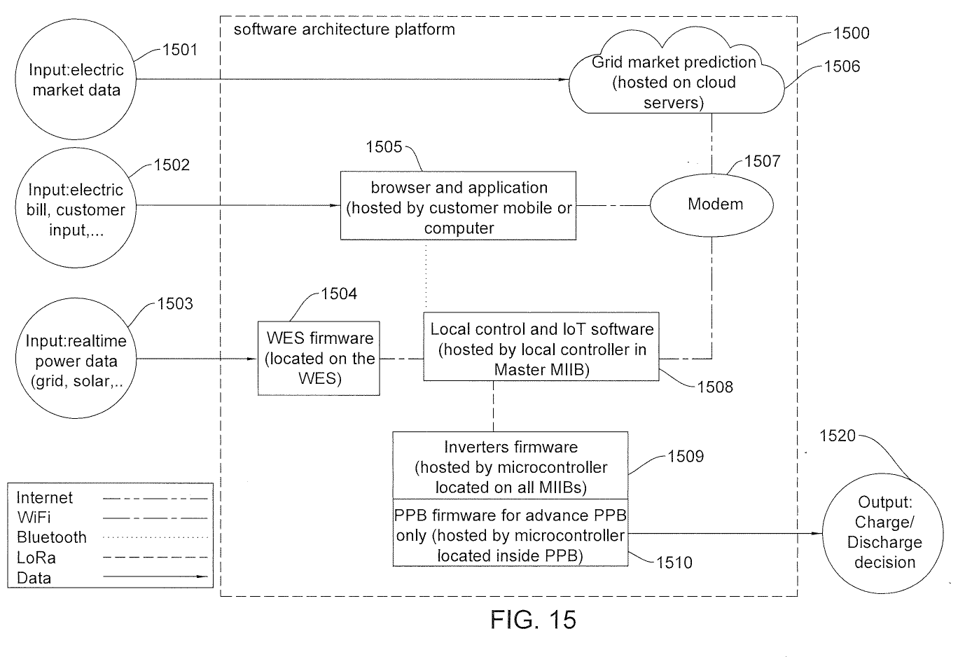

In another aspect of the present invention, the power storage device of the present invention may further comprise of a computer system. The computer system is in communication with a server for connecting to the at least one integrated inverter and power storage component also referred to as Modular Integrated Inverter and Batteries (MIIB) over a network. Further, a mobile device may be used by the customer/facility/residence for communicating with the server having a controller for commanding the at least one MIIB to discharge and to charge the at least one power storage component and wherein the controller connects to the network connector over the network and communicates with a mobile application to analyze the operation of the power storage device. Thus, the present invention provides a computer system and a computer implemented method for management of power and energy to minimize electricity cost. The computer system may comprise of one or more processors, a memory in communication with the processor and storing, in code form, the computer executable instructions to perform the computer implemented method of the present invention. FIG. 15 is illustrating the architecture of the computer implemented method of the power storage device according to an embodiment of the invention. The computer-implemented method 1500 as shown in FIG. 15 may comprise of the following steps:
receiving a plurality of data wherein
   (i) the data related to electricity market data 1501 is received via the grid market prediction hosted on cloud servers 1506;
   (ii) the customer input data 1502 such as electricity bill is received through the browser and application 1505 which is hosted by the customer mobile or computer system;
   (iii) the real time power data 1503 such as about the power grid sources, solar energy, which is received through the WES firmware 1504 located on the WES, which in turn is in communication with the local control and IoT software 1508 hosted by the local controller in the master MIIB through the LoRa® communication protocol;
analysing the input data via the inverter's firmware 1509 or in case of advance PPB utilising the PPB firmware 1510 and processing the information received; and
displaying the decision 1520 to charge or discharge the battery.

In an exemplary embodiment of the invention, the architecture of the computer implemented method 1500 of the power storage device 1000 helps to manage/optimize power and energy with the goal of minimizing electricity cost or supporting the grid infrastructure. In this regard, the customer input data may be obtained through a mobile application which may be operable on any kind of mobile device having any kind of operating system such as iOS or android wherein the mobile application helps the customers to communicate with the local controllers and microcontroller hosted by the MIIBs and advance PPB. The mobile application may also have capability to scan or upload the photos or files as well as monitor and control. Further, the customers may also provide input through a computer system using the website and browser to use the similar functions of mobile applications if they do not wish to install mobile applications. Further, the micro controller in the master MIIB and local controller and IoT are in communication through the LoRa® communication protocol. The local controller in the master MIIB 1508 communicates with the mobile application in the mobile device and the browser and application in the computer system of the customer/user 1502 via a modem 1507 for initial setups, custom control and reporting.

In an embodiment of the invention, the computer implemented method for management of power and energy to minimize electricity cost may further utilise a remote artificial intelligence (Al) engine wherein the said AI engine may comprise of a cloud-based prediction for optimization, profitability and batch control of MIIBs based on electricity market analysis and forecasting. This cloud-based optimization may further be a part of a virtual power plant (VPP) for certain customers.

Preferably, the customer input data 1502 may be provided by the customers by importing/uploading the bills history (or any other custom information) to the mobile application or through a computer internet browser. Further, the customer may also upload any custom requirement such as specific rules for charge and discharge.

Preferably the real time power data 1503 such as about the power grid sources, solar energy etc. may be provided through the WES firmware 1504 located on the WES. The real time power input data may include but is not limited to solar (or other source) generation, local grid information which is captured by WES firmware. This information provides a good visibility of the quality and quantity of customer generation.

Preferably, the data related to electricity market data 1501 is received via the grid market prediction hosted on cloud servers 1506. The customers may use a cloud engine for market analysis. The cloud engine may be any available to the customer. When the cloud engine is any available to the customer, in such a case, the display 1520 may show the status of the MIIBs as well as accept their commands for actions such as charge/discharge with the amount of active and reactive power.

Alternatively, the customers may utilise the cloud AI engine of the present invention for market analysis which is based on artificial intelligence and stochastics probability knowledge based on individual customer's information (past bill history) and electricity market information. The display 1520 may include information related to health, energy level and current active/reactive delivered power to the point of connections. The computer implemented method of the present invention may also calculate and display the hourly/daily/monthly/yearly balance sheet for electricity cost saving.

In an embodiment of the invention, there is provided a power storage device that is architecturally designed based on the modular and portable energy storage.

In an embodiment of the invention, there is provided a power storage device that is lighter than the existing energy storage systems. Furthermore, the power storage device of the present invention has minimum installation requirements and provides maximum flexibility with minimum cost.

In an embodiment of the invention, there is provided a power storage device that is smarter than the existing energy storage systems as it utilises Artificial Intelligence at the backend for market arbitrage.

In accordance with an embodiment of the invention, the power storage device of the present invention is a micro energy storage system.

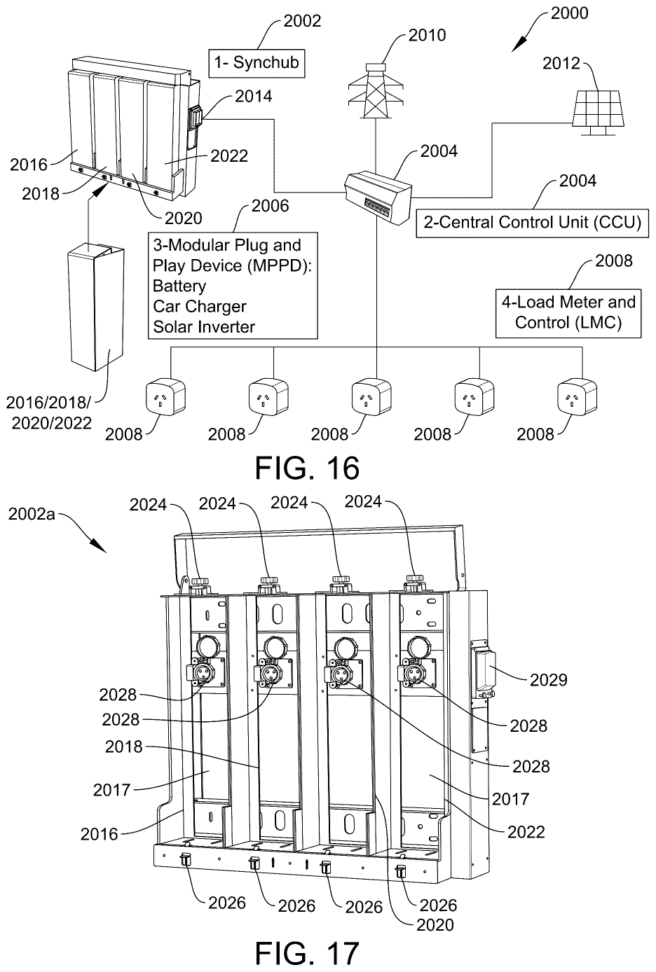

In an embodiment of the invention, as shown in FIG. 16, the hardware platform 2000 is provided for optimising residential electricity usage and to maximise renewable energy utilization. The hardware platform 2000 consists of four major components: 1) a synchub 2002, 2) a central control unit (CCU) 2004, 3) a modular plug and play device (MPPD) 2006, and 4) a load meter and control (LMC) 2008. As shown in FIG. 16, the schematic line diagram illustrates how these four major components are integrated into the existing wiring system of a home from a power source from the power grid 2010 and/or from solar panels 2012. The CCU 2004 is connected to the main distribution panel 2014, with additional electrical connections made by an electrician as necessary to link the CCU 2004 to the synchub 2002. While the installation of the CCU 2004 and synchub 2002 must be carried out by certified installers in accordance with local regulations, the Modular Plug and Play Device (MPPD) 2006 and Load Meter and Control (LMC) 2008 are designed to be user-friendly for end customers. End users can easily plug and play the MPPD 2006 and LMC 2008 as needed, without requiring professional installation. This user-friendly approach allows for greater flexibility and convenience in optimising residential electricity usage and maximising renewable energy utilization.

The synchub 2002 may be a mechanical and electrical structure designed to meet electrical and safety regulations. It can provide modularity and plug-and play capability, with four mechanically structured bays 2016, 2018, 2020, 2022 featuring special lock mechanisms (eg, top lock 2024, bottom lock 2026), as shown in FIG. 17 to secure individual Modular Plug and Play Devices (MPPDs) 2016, 2018, 2020, 2022. Each bay 2017 includes industrial-type female plugs 2028 and a waterproof electrical isolation box 2029 for compliance with regulations and safety standards.

The CCU 2004 may be a multifunctional device combining a measurement unit for monitoring power elements such as solar 2012 and grid 2010, breakers, and contactors for safety and regulation compliance (for example isolation during grid outages), and an IoT unit for communication. It connects to home WiFi, MPPDs, Load Meter and Control (LMC), and the cloud via WiFi or 4G/5G network.

The MPPD may be an AC source/load device, which may be defined as a solar inverter or an AC battery or an interface between the source/load device, which may be defined as a car charger. The MPPD can be plugged into the Synchub 2002 and communicates with the CCU 2004. It can function as a battery storage unit, electric vehicle charger, or solar inverter, among other possibilities. The MPPD 2006 can be controlled remotely via the cloud or an app through the CCU 2004.

The LMC 2008 may be a smart plug 2008 that interfaces between home appliances (for example but not limited to fridges, washing machines, pool pumps, etc) and wall power sockets. Its primary function is to monitor individual loads and enable remote control via the cloud through the CCU 2004.

The Synchub 2002 may be a hardware unit designed for integrating and organizing components of the energy management system within a residential setting. As shown in FIG. 17, a preferred embodiment for the outdoor version of synchub 2002a may consist of at least one bay 2017. More preferably at least four bays 2017, each capable of accommodating different hardware components required for energy storage and management. Each bay 2017 may be equipped with at least two locks 2024, 2026. One lock at the top 2024 and one lock at the bottom 2026. These locks 2024, 2026 can ensure secure installation and can prevent unauthorised access to the internal components. Each bay 2017 may include a waterproof industrial female plug 2028, which likely serves as a connection point for the plug-and-play installation of Modular Plug and Play Devices (MPPDs) 2016 such as battery storage units or solar inverters or Electric Vehicle (EV) charger. Additionally, each bay 2017 features an electrical isolation breaker. This component can be essential for complying with safety regulations and standards related to battery storage installations in residential homes. It can provide a means to isolate the electrical connections within each bay 2017 for easy maintenance or for safety purposes.

The synchub 2002 is a versatile hardware solution for organising and integrating the energy management components within residential environments. Thereby improving and ensuring safety, compliance, and ease of installation for electricians and homeowners.

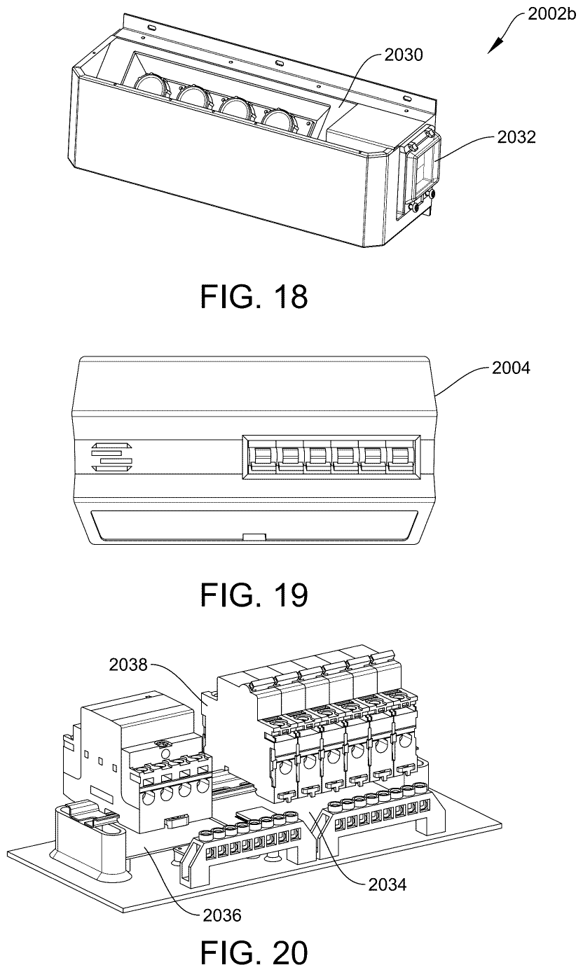

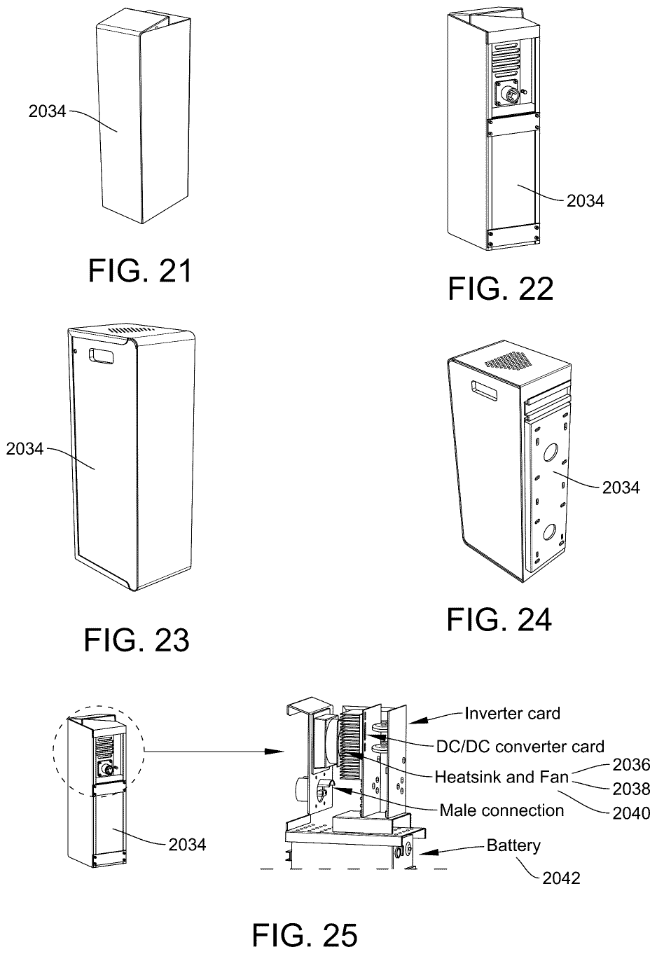

As shown in FIG. 18, a preferred embodiment for the indoor version of synchub 2002b may be specifically tailored for apartment and indoor installations, featuring a compact and weatherproof design suitable for indoor environments. The indoor synchub may feature a compact form factor optimised for indoor spaces, allowing for easy installation and integration within apartment units or indoor settings. While the outdoor embodiment prioritises weatherproofing for outdoor installations, the indoor embodiment maintains a suitable level of protection against indoor environmental conditions, such as humidity and temperature fluctuations. Unlike the outdoor version or embodiment, the indoor synchub eliminates the need for bays and locks. Instead, it accommodates Modular Plug and Play Devices (MPPDs) 2030 with their own locks and brackets, simplifying the installation process and reducing complexity.

Each MPPD 2030 can be securely mounted to the indoor synchub 2002b using its own locks and brackets thereby providing flexibility and adaptability for varying installation requirements in apartment buildings or indoor spaces. The indoor synchub incorporates features such as internal wiring, mounting points for MPPDs, and electrical isolation mechanisms 2032, ensuring efficient and safe operation within indoor environments. The indoor version of the synchub 2002b offers a tailored solution for indoor energy management applications, providing the necessary functionality and protection while maintaining a compact and simplified design suitable for apartment dwellings and indoor settings. As shown in FIG. 19, it illustrates the CCU 2004. The CCU 2004 importantly fulfils several essential functions related to regulation compliance, power measurement, communication, and safety. The CCU 2004 may comprise a power measurement card 2034 (not shown), wherein the power measurement card 2034 may be responsible for accurately measuring the current and voltage from various power sources within a home, including solar panels, the grid, and household loads. This data gathered is essential for monitoring energy usage, optimizing energy flow, and ensuring compliance with regulatory standards.

The CCU 2004 may further comprise an IoT card 2036, which facilitates communication and data management between different hardware components within the system 2000. It enables seamless integration with cloud-based services, mobile applications, and other smart devices, allowing for remote monitoring, control, and optimization of energy usage. The IoT card 2036 can have capability of WiFi connection to the home router as well as a 4G/5G connection by inserting a Sim card into the CCU.

The CCU 2004 may further comprise an electrical rack 2038, which may serve as the physical infrastructure for managing the electrical connections and ensuring safety and compliance. It may consist of multiple circuit breakers and contactors, which play a crucial role in isolating different power sources and loads as needed. The contactors and breakers are controlled automatically or manually to meet safety requirements, with some operated based on inputs from the Power Measurement Card 2034 to respond to specific conditions or events. The advantage that the CCU 2004 provides is that it combines sophisticated measurement capabilities, robust communication functionality, and comprehensive safety features to serve as the central control hub of the energy management system. Its modular design may allow for flexibility and scalability, thereby ensuring compatibility with various installation configurations and regulatory requirements.

The MPPD 2006 is a key component of the innovative research and design initiatives, utilizing advanced power conversion technology. While MPPD 2006 comprises three distinct components, they all function as AC power units and the system advantageously provides battery storage, EV charging, and solar inversion. The MPPD 2006 may have an integrated battery and inverter in one box and this device may be termed MPPD-B, in which the ‘B’ refers to the battery or integrated battery. The battery may have capacity of approximately 3 kWh of exported power and a power range of 1 to 3 kW.

Central to the innovation is the Modular Integrated Inverter and Battery (MIIB) 2034, which has transformed battery power conversion through the innovative battery inverter. In contrast with the traditional, bulky, and expensive battery inverters common in the market, this system utilizes DC/DC converter technology. This approach dramatically increases the DC voltage up to forty times more with a high frequency in the kHz range. As shown in FIGS. 21 to 24, this also advantageously achieves significant reductions in size, weight, and cost.

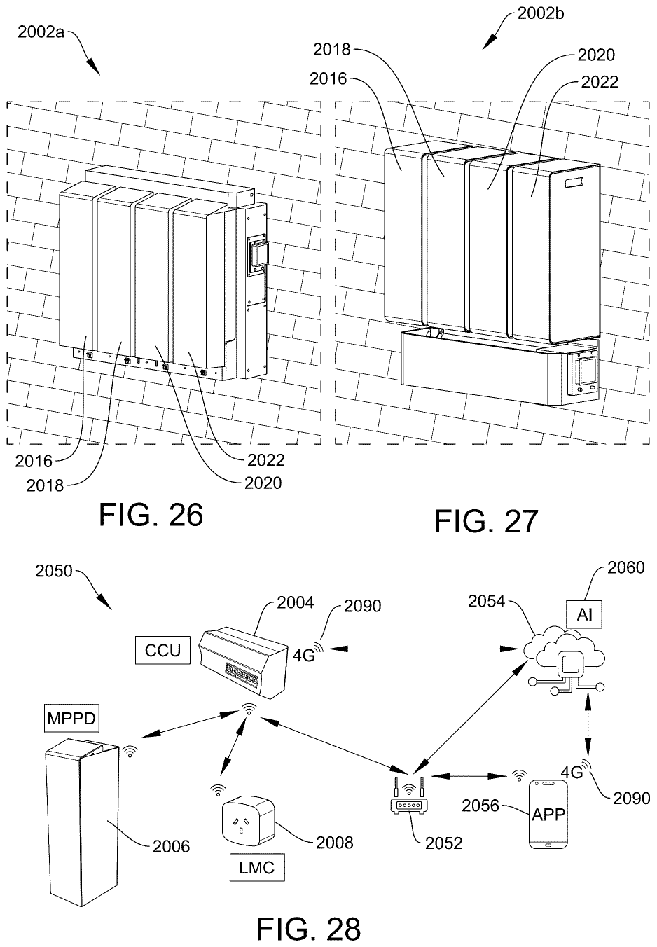

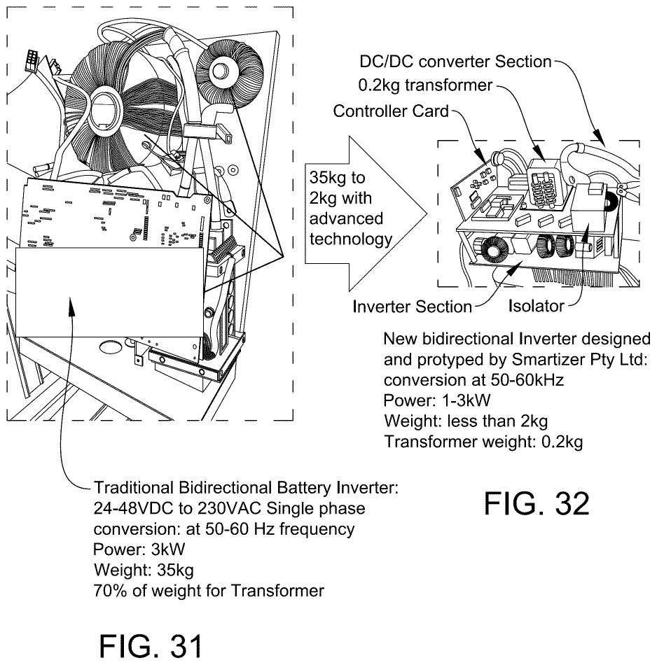

This technique enables us to employ smaller-sized transformers and leverage the full capacity of advanced ICs and IGBTs, resulting in a battery inverter weighing merely one kilogram and less than 2 kg. In stark contrast, traditional commercial models weight at least tens of times more (above 35 kg) and come at a higher cost, as shown in FIG. 31. This breakthrough positions as the first to introduce a lightweight, cost-effective AC modular plug-and-play battery solution to the market. The battery design features waterproofing for outdoor applications, with electrical connectivity ensured through the synchub 2002a. The cooling system 2036 comprises a robust fan 2038 and heatsink 2040 located at the rear of the battery 2042, expelling air into the space between the synchub 2002a and the wall 2044. Additionally, a safety push key mechanism, coupled with a male industrial plug at the rear, ensures maximum safety during the connection between the battery and the synchub 2002a. As shown in FIGS. 26 to 27, the installation process for both indoor 2002b and outdoor 2002a versions of the battery with four-units are shown. While the outdoor units are designed to withstand harsh weather conditions and require robust construction, the indoor units have a slightly different design tailored to indoor environments.

MPPD-c is referring to charger or EV charger and MPPD-s is referring to solar inverter.

The system 2000 may comprise a load meter and control (LMC) devices 2008 that function similarly to many smart plugs available in the market. The LMC 2008 will be plugged into the wall electricity socket 2042, and then the load will be connected to the LMC 2008. The primary objective of the LMC is to monitor and control the behaviour of loads within the household, facilitated by the AI decision-making capabilities through the CCU 2004.

As shown in FIG. 28, the system 2000 may provide a software and communication architecture 2050. The architecture of the hardware platform 2050 can facilitate seamless communication among its components. The Central Control Unit (CCU) 2004 serves as the central hub for controlling and managing communication between all hardware components within the system, as well as interfacing with home WiFi networks 2052 and the cloud 2054. As shown in FIG. 28, it shows a schematic of the structured communication flow between hardware components within the system.

The system may allow the CCU 2004, which is installed as the central control unit 2004 in the home, to communicate wirelessly with other hardware components such as the Modular Plug and Play Device (MPPD) 2006 and Load Meter and Control (LMC) 2008. This communication is established through wireless protocols such as WiFi, Zigbee, or LoRa, thereby ensuring flexible and reliable connectivity within the home environment. The CCU 2004 can also communicate with the home WiFi router to establish connectivity to the local WiFi network. This enables integration with the broader home network infrastructure and allows for communication with other devices connected to the WiFi network. In addition to local communication within the home, the CCU 2004 establishes communication with the cloud infrastructure 2054 and APP or mobile application 2056. This connection enables data exchange and synchronisation with cloud-based services thereby facilitating remote monitoring, management, and control of the system. The AI core algorithm 2060 may be responsible for analysing data and recommend strategies to optimize residential electricity usage and maximize renewable energy utilization. It processes input data from various sources, including electricity retailer data for cost of electricity, customer input via the APP 2056, and weather data 2062. The AI core 2060 also takes into account solar availability directly from solar panels 2012, integrating these diverse data streams to make informed energy management decisions. Based on the analysed data, the AI core 2060 generates recommendations and instructions to control the system's hardware components for efficient energy management. Customers can interact with the AI core 2060 through the APP or mobile application 2056, where they can input preferences, view energy usage insights, and receive recommendations for optimizing energy consumption. The APP 2056 can serve as a user-friendly interface for customers to monitor and control their energy usage, as well as receiving notifications and alerts from the AI core 2060. The system 2050 can maintain user preferences by providing options for scheduling adjustments and seeking user confirmation before implementing automated changes. The system 2050 can allow access to electricity retailer data 2064 as the AI core 2060 has means to communicate to the electricity retailer 2066, and thus providing real-time information on electricity prices 2068 and tariff structures 2070. This data can be crucial for optimizing energy consumption patterns to minimize costs for customers, incorporating predictions about energy market fluctuations 2072 to advise on the best times 2074 for energy purchase 2076 or sale 2078. The AI core 2060 is also in communication with weather information and sources, which allows the AI core 2060 to fetch weather data 2080 from cloud-based sources 2082 to enhance its decision-making capabilities. Weather forecasts 2080 can enable the AI 2060 to anticipate fluctuations in solar generation and adjust energy usage accordingly. By incorporating weather data 2080 into its algorithms, the AI core 2060 can optimize energy storage and consumption strategies based on forecasted weather conditions, ensuring optimal use of solar energy. It is also an advantage to provide security and data integrity 2084 to the system 2050 to protect user data and ensure the safe automation of household energy management. These measures can include encryption of data transmission and strict adherence to privacy laws to safeguard user information. The AI core 2060 can leverage cloud-based computing and data analytics to deliver intelligent energy management solutions to customers, enabling them to optimise their electricity usage, and to reduce costs, and increase the utilisation of renewable energy sources. The AI sophisticated algorithm is advantageously designed to seamlessly integrate and analyse disparate data sources such as solar data, weather forecasts, and electricity prices to make the best possible decisions for energy management without compromising the user's comfort or preferences.

In another embodiment, optionally, the CCU 2004 may also be equipped with 4G or 5G connectivity capabilities 2090. This provides an alternative communication channel for scenarios where WiFi access is limited or unavailable. Customers can utilize cellular connectivity to ensure continuous communication with the cloud and access the system and/or services remotely. By serving as the central communication hub, the CCU can advantageously enable seamless integration and coordination of the system's hardware components, as well as connectivity with external networks and cloud-based services, which thereby enhances the functionality and usability of the system's platform.

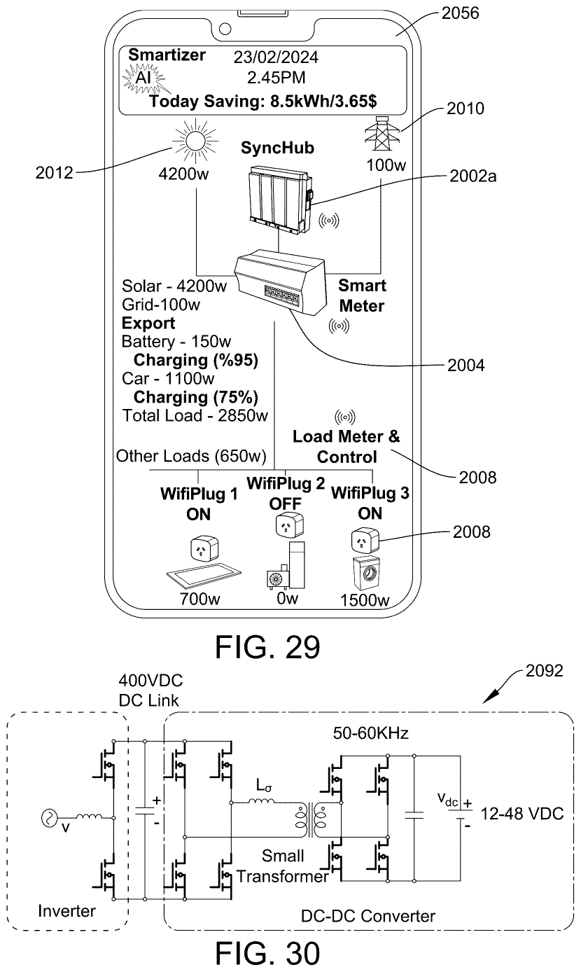

The AI core algorithm and decision-making engine can reside on the cloud, enabling seamless communication with customers through the system's mobile application (APP) 2056. The following describes how the AI core functions and interacts with various data sources:
AI Core Algorithm and Decision Maker:
   The AI core algorithm can be responsible for analysing data and making decisions to optimise residential electricity usage and maximize renewable energy utilization. It processes input data from various sources, including electricity retailer data (for cost of electricity), customer input via the smartphone/mobile app, and weather data. Based on the analyzed data, the AI core 2060 generates recommendations and instructions to control the system's hardware components for efficient energy management.
Communication with Customer via APP:
   The system then communicates with the customer via the APP. Customers interact with the AI core through the mobile application. They can input preferences, view energy usage insights, and receive recommendations for optimizing energy consumption. As shown in FIG. 29, the APP 2056 can advantageously serve as a user-friendly interface for customers to monitor and control their energy usage, as well as receive notifications and alerts from the AI core 2060.
Access to Electricity Retailer Data:
   The AI core 2060 has access to electricity retailer data, providing real-time information on electricity prices and tariff structures. This data is crucial for optimizing energy consumption patterns to minimise costs for customers.
Integration with Weather Data:
   The AI core fetches weather data from cloud-based sources to enhance its decision-making capabilities. Weather forecasts enable the AI to anticipate fluctuations in solar generation and adjust energy usage accordingly. By incorporating weather data into its algorithms, the AI core can optimize energy storage and consumption strategies based on forecasted weather conditions. The system's AI core leverages cloud-based computing and data analytics to deliver intelligent energy management solutions to customers, enabling them to optimize their electricity usage, reduce costs, and increase the utilization of renewable energy sources.
The APP or mobile application:
   The mobile application or APP 2056 serves as a user-friendly interface for customers to interact with the system's hardware components and cloud-based services. The overview of the structure of the mobile application is as follows:
Dashboard:
   The dashboard can provide an overview of key energy metrics, including current energy consumption, solar generation, battery status, and electricity costs. As shown in FIG. 29, customers can view real-time data and insights to monitor their energy usage and track savings over time.
Control Settings:
   The control settings allow customers to customize their energy management preferences and settings. Customers can set schedules for charging/discharging the battery, adjust load control settings for specific appliances, and configure energy-saving modes.
Energy Insights:
   The energy insights can provide detailed analytics and reports on energy usage patterns, cost savings, and provide an indication of environmental impact. Customers can access historical data and trends to gain insights into their energy consumption behavior and make informed decisions for optimization.
Notifications and Alerts:
   The application can send notifications and alerts to customers for important events such as low battery levels, peak demand periods, or unusual energy usage patterns. Customers can stay informed about their energy system's performance and take timely actions as needed.
Remote Control:
   Customers can have remote control capabilities to manage their energy system from anywhere via the mobile application. They can remotely adjust settings, initiate charging/discharging cycles, or override automated decisions based on their preferences.
Integration with Cloud and CCU:
   The mobile application can communicate with the system's cloud infrastructure and the Central Control Unit (CCU) installed in the home. It serves as a bridge for data exchange between the customer's mobile device, the system's hardware components, and the cloud-based AI core.
User Profile and Settings:
   Customers can manage their user profiles, preferences, and account settings within the mobile application. They can also access help resources, contact support, or provide feedback to improve the user experience. The mobile application can empower customers with intuitive control, insights, and monitoring capabilities for managing their residential energy usage effectively and maximising the benefits of renewable energy integration.

In another embodiment of the present invention, as shown in FIG. 30, a bidirectional inverter 2092 has been engineered with a power range of between 1 kW to 3 kW. This inverter was specifically designed to facilitate the connection between a 4 to 16-cell lithium iron phosphate (LFP) battery pack and a single-phase 220 V, 50 Hz or 60 Hz grid. The intended application of this inverter was for residential energy storage purposes. The focus of the design process was to create an inverter that would be both lightweight and cost-effective. This would allow for increased portability and affordability, making it an attractive solution for residential battery storage applications.

By ensuring that the inverter is lightweight and compact, it thus makes it easy to transport and install in residential settings. Further, by implementing design strategies and components that would minimize production costs without compromising performance or reliability. Further, by ensuring seamless integration with lithium iron phosphate battery packs and single-phase grids commonly found in residential environments. By having the inverter with bidirectional capability, it enables the inverter to efficiently manage the flow of energy between the battery pack and the grid, allowing for both charging and discharging operations as needed. By achieving these objectives, the designed bidirectional inverter would provide homeowners with a practical and economical solution for residential energy storage, supporting the transition towards sustainable and self-sufficient energy systems.

In another preferred embodiment of the present invention, the new method for the design of a bidirectional inverter may be based on the high frequency DC to DC converter principle and the use of a low-cost and lightweight ferrite-core transformer has been developed and prototyped. As shown in FIG. 30, the figure shows the inverter topology. The inverter may consist of an LCL-filtered voltage source converter (VSC) as defined in the inverter side and a dual active bridge (DAB) DC-DC converter, both operated at a switching frequency above 50 kHz. The VSC may be adopted as a fast DC bus voltage control strategy with a unified current harmonic mitigation. Meanwhile, the DAB DC-DC converter employed a proportional-integral regulator to control the average battery current with a dynamic DC offset mitigation of the medium-frequency transformer's currents embedded in the single-phase shift modulation scheme. This presents a synchronization technique between the switching signal generation of the two converters and the sampling of analog signals for the control system. The prototyped inverter had an efficiency above 90% and a total harmonic distortion in the grid current smaller than 1.5% at the battery power of 1 kW for 12V and 3 kW for 52 VDC.

The grid voltage v is converted to a 400 V DC voltage through an LCL-filtered VSC as indicated by inverter section. A DAB DC-DC converter well suits the second-stage battery converter as the voltage matching and galvanic isolation are achieved via the MF transformer. Moreover, the DAB DC-DC converter exhibits high efficiency. The VSC adopts the cascade control structure with the bus voltage control as the outer loop and the grid current control as the inner loop. The VSC can inject reactive power through the reference current for grid support functionality. The inverse park transformation phase-locked loop (PLL) provides the estimated angle of the grid voltage for synchronization with the grid. The battery current is regulated by a proportional-integral (PI) controller with the reference phase difference between the primary and secondary voltages before and after of the transformer, which are generated by the LV and HV bridges with the single-phase shift (SFS) modulation. The VSC and the DAB DC-DC converter's control systems and switching signal generation are implemented on the controller card.

The transformer (LV to HV) has been designed and prototyped with specific core material for characterisation for inductance, capacitance and resistance characteristics. The VSC adopted a bus voltage control with a unified harmonic mitigation strategy. The charge and discharge operations exhibited a total system efficiency better than 90% and total harmonic distortion in the grid current lower than 1.5%. Furthermore, this prototype advantageously optimises the design of the ripple filter on the battery side. As shown in FIG. 32, the successful development of this bidirectional battery inverter marks a significant milestone for the system or platform and its vision for portable home battery storage. With a weight of less than 2 kg, this achievement can advantageously provide modularity, portability, and affordability to the user. By integrating this lightweight and cost-effective inverter into its platform, the platform can offer homeowners a versatile solution for residential energy storage. The inverter's bidirectional capabilities can advantageously enable efficient energy management, thus allowing users to seamlessly charge and discharge their battery packs as needed. This development provides practical and accessible solutions for optimizing renewable energy usage in homes. With the addition of the bidirectional battery inverter to its platform or system, it strengthens its position as a leader in the residential energy storage sector and through this system, it empowers homeowners to embrace sustainable and self-sufficient energy systems.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A power storage device comprising of at least one power storage component with at least one inverter; wherein the at least one power storage component is electrically connectable to an electrical panel which in turn is in electrical communication to an isolation switch disposed in a main switchboard and wherein the at least one power storage component is integrated with the at least one inverter; an electrical sensor in wireless communication with the at least one integrated inverter and power storage component, wherein the electrical sensor is adapted to capture power generation of external sources; a computer system comprising a server for connecting to the at least one power storage device over a network and mobile device for communicating with the server having a controller for commanding the at least one inverter to discharge and to charge the at least one power storage component; and wherein the controller connects to the network connector over the network and communicates with a mobile application to analyze the operation of the power storage device.

2. The power storage device as claimed in claim 1, wherein the power storage device is a micro energy storage system.

3. The power storage device as claimed in claim 1, wherein the at least one power storage component is integrated with the at least one inverter.

4. The power storage device as claimed in claim 1, wherein the power storage device comprises a plurality of the integrated inverter and power storage components to get a higher energy storage wherein the said plurality of integrated inverter and power storage components are arranged in series.

5. The power storage device as claimed in claim 1, wherein the first integrated inverter and power storage component is the master integrated inverter and power storage component, and the additional plurality of integrated inverter and power storage components are controlled through the master integrated inverter and power storage component.

6. The power storage device as claimed in claim 1, wherein the electrical panel of the power storage device is a specific plug board suitable for connection with an isolation switch located in the man switchboard functioning to isolate a group of the integrated inverter and power storage components from both grid and load.

7. The power storage device as claimed in claim 1, wherein the electrical sensor is able to capture power generation of external sources such as solar, wind or other energy storage.

8. The power storage device as claimed in claim 3, wherein the integrated inverter and power storage component comprises of a casing wherein the casing has two parts namely a base part and a cover part, wherein the base part houses at least one power storage component such as at least one battery or a cell, a power conversion board, a control board, a cooling system and a LED light.

9. The power storage device as claimed in claim 8, wherein the at least one power storage component is a battery wherein the battery is chargeable and dischargeable.

10. The power storage device as claimed in claim 9, wherein the components housed in the base part of the casing are connected together with a prefabricated board wherein the prefabricated board is equipped with components such as bus bars, electrical wires and temperature sensors and wherein the prefabricated board is tightened by screws to the terminals of the at least one battery.

11. The power storage device as claimed in claim 8, wherein the power conversion board is a bi-directional converter which inverts DC power of the at least one battery to AC power and comprises of a circuitry of battery management system and DC contactors and wherein the control board comprises of Advanced RISC Machine (ARM) based processor and performs all major high level control functions as well as communication functions.

12. The power storage device as claimed in claim 1, wherein the computer system may comprise of one or more processors, a memory in communication with the processor and storing, in code form, the computer executable instructions to perform the computer implemented method for management of power and energy wherein the method comprises the steps of:
receiving a plurality of data wherein (i) the data related to electricity market data is received via the grid market prediction hosted on cloud servers; (ii) the customer input data is received through the browser and application which is hosted by the customer mobile or computer system; and (iii) the real time power data, which is received through the WES firmware located on the WES, which in turn is in communication with the local control and IoT software hosted by the local controller in the master MIIB through the LoRa® communication protocol;
analysing the input data via the inverter's firmware or in case of advance PPB utilising the PPB firmware and processing the information received; and
displaying the decision to charge or discharge the battery.

13. The power storage device as claimed in claim 12, wherein the computer implemented method for management of power and energy to minimize electricity cost may further utilise a remote artificial intelligence (Al) engine wherein the said AI engine may comprise of a cloud-based prediction for optimization, profitability and batch control of integrated inverter and power storage components based on electricity market analysis and forecasting.

14. The power storage device as claimed in claim 13, wherein the customer input data comprises electricity bill data; and wherein the real time power data comprises data relating to power grid sources and solar energy.

15. The power storage device as claimed in claim 1, wherein the power storage device is architecturally designed based on the modular and portable energy storage.

16-28. (canceled)
